(19) United States
(12) Patent Application Publication
(10) Pub. No.: US 2011/0281652 A1
(43) Pub. Date: Nov. 17, 2011

(54) Touch Music Player

(76) Inventor: Marc Laverdiere, Wakefield, MA (US)

(21) Appl. No.: 13/146,679

(22) PCT Filed: Feb. 1, 2010
(86) PCT No.: PCT/US10/22744

§ 371 Date: Jul. 28, 2011

Related U.S. Application Data
(60) Provisional application No. 61/149,339, filed on Feb. 2, 2009.

(51) Int. Cl. A63F 9/24; G06F 3/041

(52) U.S. Cl. 463/37; 345/173

(57) ABSTRACT

Methods and systems for a media player having one-touch capability are disclosed. This capability reduces the complexity of MP3 players such that a one-year-old could use and enjoy the device, yet be desirable to users of any age. Also disclosed are the means to manufacture, sell, and provide various levels of user customization for the media player. Other embodiments provide an MP3-style device with the potential for use in a wide range of additional applications.

This application claims priority of U.S. Provisional Patent Application Ser. No. 61/149,339, filed Feb. 2, 2009, the disclosure of which is incorporated herein by reference in its entirety.

### TECHNICAL FIELD OF THE INVENTION

The present invention generally relates to MP3 players and their corresponding computer software interfaces to download music to the devices and more particularly to embodiments that improve ease-of-use and user-friendliness associated with accessing audio and video clips. The present invention also includes means to manufacture and means to sell an MP3 player device and corresponding music, functions, and images for an MP3 player device.

### BACKGROUND OF THE INVENTION

A wide variety of MP3 players are readily available for consumers. These players generally consist of a headphone jack, a play button, a next song button, a previous song button, and a pause and/or stop button with some means to power on and off. Higher-end MP3 players typically have a display screen with some means to toggle through a large menu of songs that can be organized any way the user desires through the use of a computer. Many MP3 players include some means to interface with a computer to download songs, typically through a USB port/cable. Some MP3 players, such as the Sansa® Shaker™, have on-board speakers.

The typical focus of MP3 technology today is to offer a means to store and have immediate access to as many songs as possible. While maximizing the number of songs is often preferable, such devices are often complex and require some level of understanding to navigate through the device's library of songs. This complexity limits the consumers that can use the device. A media player that allows the user to play any media with a single touch of the device would be beneficial. It would also be advantageous if such a device could be configured for use in a wide range of applications.

### SUMMARY OF THE INVENTION

The problems of the prior art are alleviated by the present invention, which discloses methods and systems for a one-touch feature, reducing the complexity of MP3 players such that a one-year-old could use and enjoy the device, yet be desirable to users of any age. Other embodiments enclosed herein provide the means to manufacture, sell, and provide various levels of user customization for an MP3 player device. Other embodiments enclosed herein provide an MP3-style device with the potential for use in a wide range of additional applications.

### BRIEF DESCRIPTION OF THE DRAWINGS

FIGS. 1A-1B each show a Touch Music Player in accordance with an embodiment of the invention;

FIGS. 2A-2D show an example sequence of operations for the embodiment of FIG. 1A;

FIGS. 3A and 3B show a display card of the present invention;

FIG. 4 shows an exploded view of the device of FIG. 1A;

FIGS. 5A-5E show a display card having enhanced functionality being inserted into the device in accordance with one embodiment of the invention;

FIGS. 6A-6F show an interchangeable button according to one embodiment of the invention;

FIG. 7 shows a representative software interface used to configure the device according to one embodiment;

FIG. 8 shows a representative software interface used to configure the device according to one embodiment;

FIGS. 9A-9B show two cases, which are modified based on the hardware configuration;

FIG. 10 shows another embodiment of the present invention;

FIGS. 11A-11B show another embodiment of the device of FIG. 10;

FIGS. 12A-12B shows another embodiment of the present invention where a display card is inserted into a device in accordance with another embodiment of the invention; and

FIG. 13 shows another display card of the present invention.

### DETAILED DESCRIPTION OF THE INVENTION

Throughout this disclosure, when referring to audio capabilities of the device, it is understood that other media, such as video content, capability can be easily achievable with any of the described functionality used to access audio content. Furthermore, the term “Button” or “touch sensitive regions” can mean any key, switch, knob, sensor, push button, pull button, lever, capacitively coupled area, thermally sensitive region or some other method not mentioned, which will execute the described functions of pushing a button or contacting a touch sensitive region as described herein.

The device of the present invention is intended to simplify the operation of MP3, or any media, players. As described above, MP3 players typically have an interface that allows the user to browse through their current library of songs. This interface may group songs according to artist, genre, album title, or some other category. To select a particular song, the user navigates through this user interface to find the desired song.

In contrast, the present invention allows the user to commence playing of that song (or other media) through a single touch of the device. In general, the device, also known as the Touch Music Player, or simply the Touch Player, has a pad with a plurality of touch sensitive regions. The act of pressing any of these touch sensitive regions causes the device to begin playing the media associated with that region. Thus, actuation of a single button causes the device to begin playback of a media file. In some embodiments, the number of accessible media files is equal to the number of buttons. In other embodiments, multiple media files can be associated with each button. For example, actuation of a touch sensitive region may commence playback of a first media file. Actuation of the same region, while that media file is playing, may commence playback of a second media file. Repeated actuation of a region may be used to select among multiple media files associated with that region. In addition to the touch sensitive regions, the device includes an audio output, which may be built-in speaker(s) or headphone jack(s). The device may also include means to adjust the volume and separate means to disable or turn off the device.

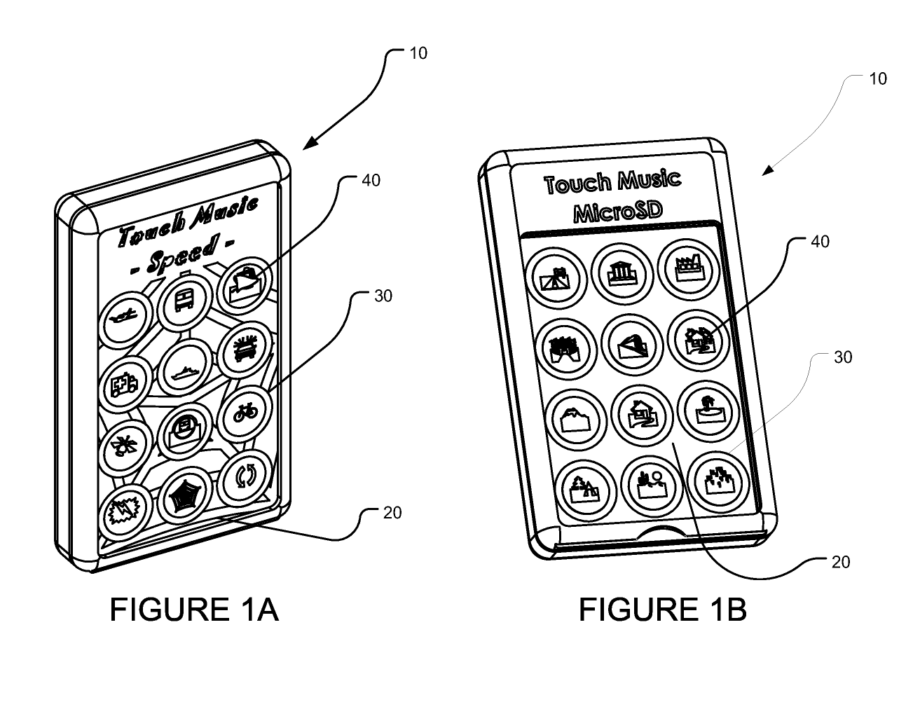

One embodiment of the Touch Music Player 10, shown in FIGS. 1A and 1B, includes a multi-keyed/multi-buttoned pad 20. The touch sensitive regions on the pad includes a plurality of button images or buttons 40. In addition, one or more illuminating features may be present as well. In some embodiments, the illuminating features correspond to a specific button 40. In one specific embodiment, the illuminating features comprise rings 30 surrounding each of the plurality of buttons 40, where each button 40 represents a single song, audio-clip, video clip, other media file, or a collection of media types. The button may be an actual button, or may be any touch sensitive device, adapted to detect actuation caused by pressure or any other button like capability described or not described herein. The embodiment further comprises an external/on-board speaker or headphone jack, means to increase or decrease the volume, and the typical packaging and electronics required for an MP3 style device.

In some embodiments, the actuation of a single key or button 40 may perform several functions. For example, pressing an individual key or button 40 may cause the device 10 to power on, illuminate the lighted ring 30 surrounding that key 40, and start the song(s), media file(s) or audio clip(s) associated with that button 40. In some embodiments, the actuation of a second key or button may cause the device to illuminate the light surrounding that second button, stop the playback of a previous media file, and start the song(s), media file(s) or audio clip(s) associated with that second region. In some embodiments, pressing the active button can stop the song or media file and power down the device. The active button is defined as that button with which the playing media is associated.

The intent of this embodiment of the Touch Music Player is ease-of-use. For example, it is desirous that a youngster can operate the device. This goal is achieved by the simple user interface. In one embodiment, pressing any button serves to turn music on, pressing that same button will turn the music off, and pressing any other button will switch to that button's corresponding song or media file. The device's ease-of-use should not be underestimated; the simplicity of the current embodiment allows users to instantly access desired audio clips with a single button rather than dealing with menus and searching and scrolling.

In some embodiments, a separate power switch can be used to power on and off the device. In this embodiment, pressing an active button can either stop the currently playing song or access another song associated with the same button, allowing for numerous audio clips or media files to be associated with the same button. In some embodiments, a separate power switch is located on-board the device; pressing a button will start the song for a particular button, stop the song for a particular button, or switch to a new button's song when the power has been enabled.

In some embodiments, the active button can be pressed to perform some other function, such as switching to a next media file (i.e. song) that is also associated with that button, allowing for numerous files to be associated with a single button. Pressing the active button could also cause the active song to fast forward, pause, play slowly, play backwards, reduce in volume, increase in volume, etc. Additional functions will be discussed herein, including custom code capability, which can be assigned to a song button, a set of buttons, and/or even a user-assigned function button.

FIGS. 1A and 1B show two images of possible Touch Music Player embodiments 10. FIG. 1A shows a device where the display window is integrated into the device and FIG. 1B shows a device where the display card is easily removable. These two devices 10 feature a touch sensitive pad 20 having a 12-button format. Each button 40 is surrounded by a ring 30, which may be illuminated, such as by an LED or LCD, indicating that that button is active.

While FIG. 1A describes an illuminating ring 30, the invention is not so limited. In some embodiments, the illuminating feature can illuminate the whole button 40 or a portion of the button. The illuminating feature may be in close proximity to the button to indicate which button is active. In some embodiments, the illuminating feature can be positioned at a location on the device separate from the button, but still indicative of which button is currently active. For example, the illuminating features may be in the same pattern as the buttons, or the same labeling scheme can be applied to both the buttons and the illuminating features. The illuminating features and buttons can also be matched based on their sequential order. The button images do not necessarily have to have defined boundaries either. Images could generally overlay a set of touch sensitive regions or button mechanisms such that the illuminating feature, such as a back-lit region for the image, are aligned only enough that the user can distinguish which images are currently active. The button images may be part of a single image such as a cartoon character for example. So pressing the characters hand may illuminate the hand and active the corresponding touch sensitive region or button and pressing the characters mouth could activate another touch sensitive region. This could be done for any image or images whether they are of a person a place or an object or text any combination thereof or other definable element not mentioned.

It is also envisioned that in some embodiments, no illuminating feature is necessary and the method of operation described herein could be performed without the use of such a visual indication.

In some embodiments, the active key or button can be pressed to stop the current song or audio clip and shut off the illuminating feature. The system may or may not power down with this action. In some embodiments, the illuminating feature may serve additional purposes. For example, an illuminating light for a particular button can produce multiple colors depending on the power level of the battery. In one embodiment, the light may be green when the battery is more than 50% charged and orange when the battery is less than 50% charged. In other embodiments, the light can flash or blink at varying frequencies depending on the power level of the battery. Optionally, the device may also give an audio indication of decreased power level, a feature typical of many cell phones.

In some embodiments, the illuminating feature for a single button could include multiple illuminating elements. An illuminating ring surrounding a button could be broken into segments where each segment has its own light. The lights could be used as indicators of power level, song number associated with the button, button mode, function, volume, or any other characteristic which may be of interest to the user.

In some embodiments, two buttons can be pressed at the same time to start a song that is not activated by pressing either button individually. This type of feature is common in car stereos where two buttons located adjacent to each other can be pressed simultaneously to select a radio station that has been stored with the two button selection, which may differ from the station stored on either individual button. With this method, both buttons could illuminate to indicate that the audio clip associated with the two buttons is currently active. Any of the active buttons could be set up such that pressing them simultaneously or pressing either one individually causes the current song to stop.

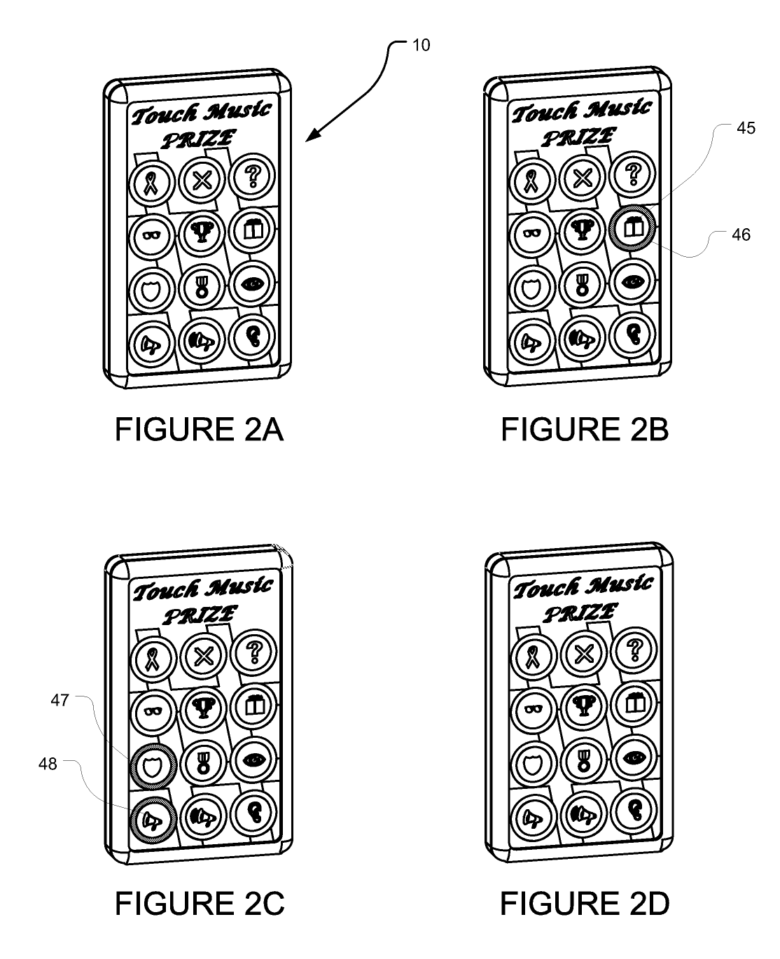

FIGS. 2A-2D show an example sequence of operations for a Touch Music Player. FIG. 2A shows the device 10 at rest, where no media file is being played. In FIG. 2B, a button 45 has been pressed. The actuation of this button may cause a song or media file to begin playing. In addition, the button that was actuated may be indicated by an illuminating feature, such as an illuminated ring 46. At a later time, as shown in FIG. 2C, two buttons 47 and 48 are simultaneously actuated to start another song that is not stored on either button individually. At a later time, as shown in FIG. 2D, either or both of the two active buttons are pressed or the song has completed and the device is not configured to repeat or continuously play the content of additional buttons whether sequential or random, which stops the music from playing on the device. This is indicated by the absence of any button illumination.

The device 10 includes control logic that is in communication with the touch sensitive regions. The control logic may include a general purpose processing unit or a special purpose processing unit. The control logic also includes a storage element, such as read/write memory or read-only memory. Various technologies, such as DRAM, RAM, FRAM, FLASH, EPROM, EEPROM, ROM, and others, can be used to create the storage element. The storage element is used to store the media files, such as songs. In some embodiments, the storage element is also used to store the instructions used by the processing unit to implement the functionality described herein. In other embodiments, the processing unit may have its own dedicated storage element containing these instructions. For example, the operations described above, such as illuminating a button, playing a particular media file, switching to a second media file when a second button is pressed, turning off the device, and others, are all executed by the control logic, based on the instructions provided to the processing unit.

In addition, the device also contains a power source, which is typically a battery to allow portability. Furthermore, the device includes a housing, which may include an opening into which a plastic card can be installed. Such an opening may include a slot or compartment in the housing.

In some embodiments, a plastic card or overlay and means to install the plastic card onto the face of the Touch Music Player are included. This plastic card or sheet can contain one or more descriptive pictures, text, labels, etc. used to describe, represent, or depict the audio content for one or more of the buttons.

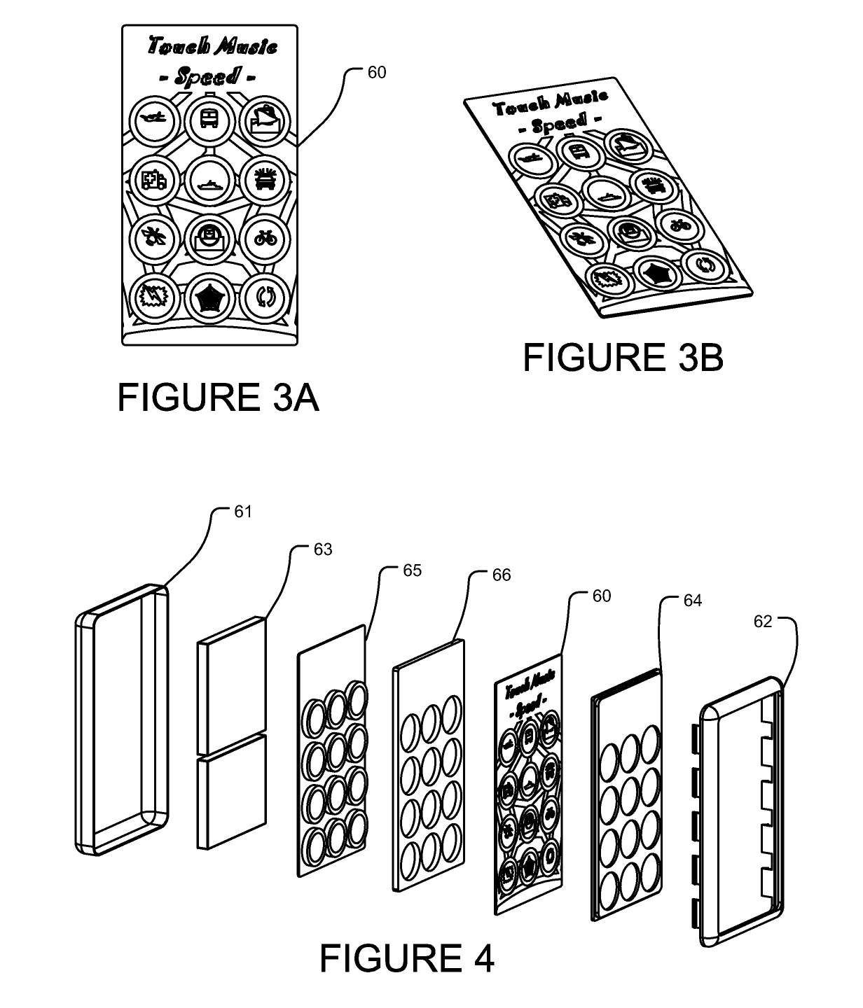

FIGS. 3A and 3B show a display card 60 that may be used with the present invention. In some embodiments, the depicted card 60 is a thin plastic sheet that is transparent or translucent to allow the illuminating light of the Touch Music Player to shine through. The type of button (sensor, compressible, etc.) used may determine the card's thinness to enable the user to compress the button. By introducing an MP3 player where the look and feel of the device are transformed by simply changing a single low cost display card, an endless number of possibilities allow individual users to personalize their product.

In the present invention, a Touch Music Player display card can be fabricated as an integral part of the device or offered as an interchangeable feature designed to be changed out with or when the music is changed.

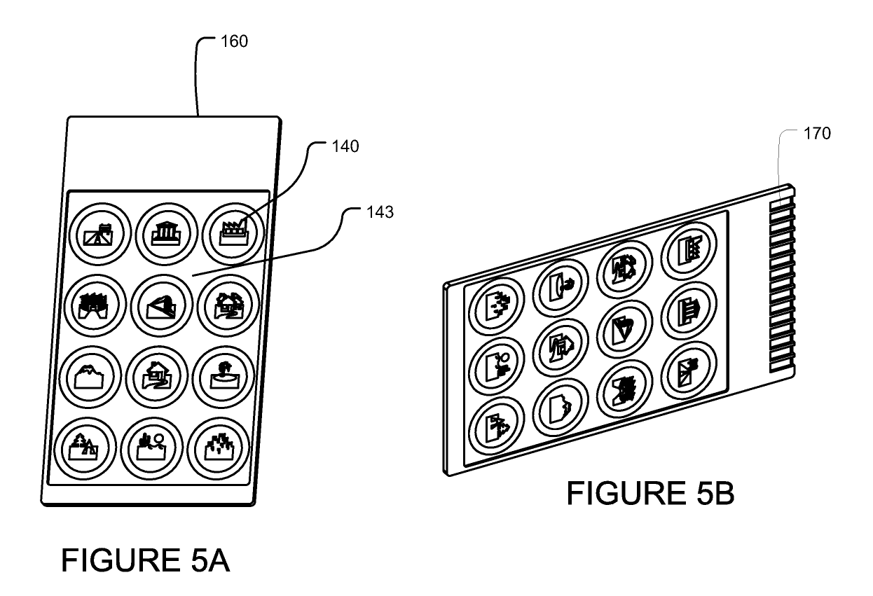

An example of how an integral display card Touch Music Player could be constructed is illustrated in the exploded assembly view of FIG. 4.

FIG. 4 shows how a display card may be positioned within an MP3 player such that the card is not readily interchangeable. Hard-coding music into the device with a single non-interchangeable display card allows the device to play only the music associated with the particular button depictions. Using a single transparent or translucent or semi-transparent or semi-translucent plastic sheet for the display card, images can be printed onto the card for button and background displays with a circular space encompassing the images where the illuminating rings show.

The design of this particular embodiment of the Touch Music Player is similar to the assembly of traditional MP3 players with a metal back cover 61 and the snap fit front plate 62. Although a battery pack 63 is illustrated in this example, it may be desirable for a Touch Music Player to be designed with disposable batteries instead. In the most common form of the Touch Music Player, it is expected that the storage element (i.e. hard drive, flash memory, etc.) will have a limited amount of storage space due to the limited number of songs and software that it is expected to contain. Large hard drives and video displays, two of the more expensive components on present day MP3 players, would not be required in most forms of the Touch Music Player, providing cost advantages.

In the Touch Music Player exploded view shown in FIG. 4, the display card 60 is sandwiched between a clear display cover 64 and the PCB (printed circuit board) 65 containing the buttons and illuminating button rings. The control logic and storage element may reside on the PCB 65. Depending on the type of touch sensitive technology used, it may be necessary to incorporate a display card backing 66, to fill the space between the PCB 65 and the display card 60. For example, the use of buttons (as shown in FIG. 4) would require the use of a display card backing 66. However, touch sensitive regions, such as capacitively coupled regions, which are very thin, may not. In this configuration, the only significant variables between different Touch Music Players are the display card 60, software, and music installed on the device, allowing relatively inexpensive product customization. In addition to the non-interchangeable display card, in some embodiments, the corresponding music and any corresponding software may be hard-coded into the device so that users are unable to make changes to the device 10 once they purchase it, at least not without considerable effort and/or difficulty.

The use of limited components with fixed functionality also allows for the rapid deployment of different versions of the device. For example, in one version, the display card may depict twelve commonly known children's songs. In this embodiment, the twelve songs would be stored in the storage element in the PCB board 65. In a second embodiment, twelve songs for a particular band may be depicted on the display card and stored in the storage element. Thus, it is simple to introduce new, customized versions of the device with minimal changes.

There are a variety of ways in which the display card can be employed.

In some embodiments, a standard display card is available with a collection of hard-coded music and software. This is typically a pre-loaded device with the songs and buttons of a particular artist, band, category, or genre of music permanently labeled with the corresponding songs (potentially a huge collectible item). In this scenario, images on the display card may have relevance to the songs associated with each button or region.

In some other embodiments, a standard display card is used without pre-loaded music. The music and software can be added or removed through a PC interface even though the display card cannot be changed. In this case, the images cannot be associated with the underlying media.

In some embodiments, the user may have the ability to select a customized display card, selecting it from a library of art for generating desired background and button displays made available to the user.

In some embodiments, a fully customized display card can be used, where users submit their picture files for generating a card or insert their personal picture files into a display card template using a corresponding software interface either on-line, in-store, or locally installed on a personal computer.

Even though these modifications may appear to customize the device, customization does not need to complicate the manufacturing process. Currently, other companies offer “custom” monogramming for their devices. When customers place orders for a device on-line, they can opt to have a monogram added. Monogram examples are provided so that a user can click on sample statements; fonts and the example are displayed on an image of the device, providing users with a sense of what their personalized saying (or one of the generic statements) may look like. The display also depicts the monogram on the particular color device the user had selected for purchase. A similar process could be applied to the present invention. For example, users would configure their device with background art, button art, and software (e.g. music, video, functions, games, code) and place their order. The software could be loaded onto the device and the display card printed (or fabricated by whatever means necessary) at the last steps of the manufacturing process. The display card would be installed into the device, completing the assembly process. Therefore, the only customization of the actual device occurs in the last steps of the manufacturing process.

A hard-coded Touch Music device, with a fixed set of media files, could be sold as a disposable device with an integral battery. This type of device could be advantageous for selling the top 10 billboard hits for a given week, for instance. Each week, a new disposable device containing the top 10 songs for that week or the previous week could be made available to customers for purchase.

In another embodiment, Touch Music users could return their old devices for new devices when they want new content or they could bring in or send back their devices to have new music and displays installed. Another option could allow users to simply exchange their devices for new devices, similar to a Netflix-type service where customers have a certain number of DVDs at any given time, then return the DVDs in their possession for DVDs they have preselected on-line.

In some embodiments, display cards may be made to be interchangeable by the user. Interchangeable display cards may be simple plastic cards that users change out as they change their music. In other embodiments, the display cards may be more sophisticated with additional functionality. For example, the display card may include a keyed feature or readable mechanism that the Touch Music Player can identify.

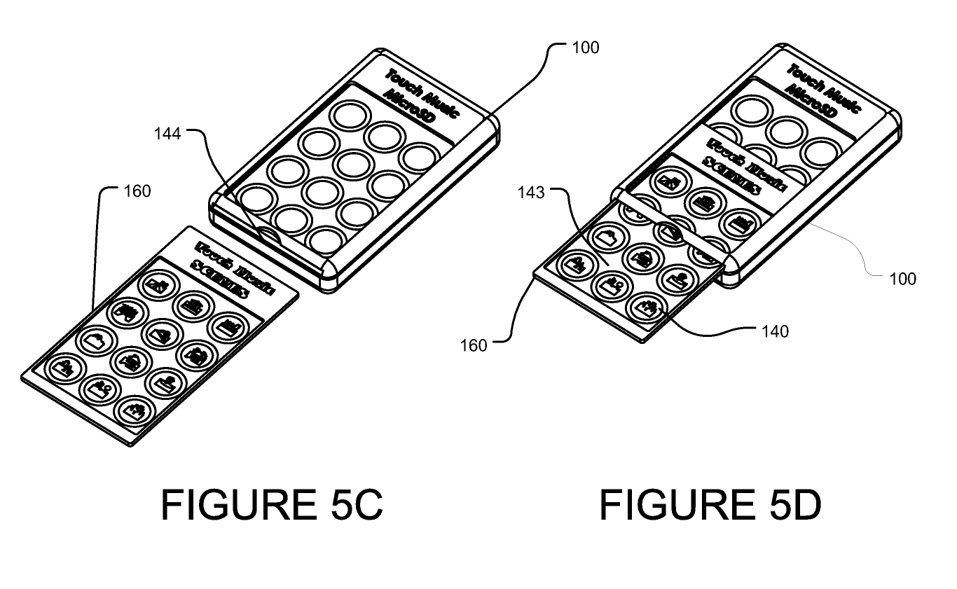

An example of a display card 160 having additional functionality is shown in FIGS. 5A and 5B. FIG. 5A shows a front perspective view and FIG. 5B shows a rear perspective view of the display card 160. The models show a design example of a clear plastic display 143 with the featured button images 140 built into a case. The display card 160 also has an identification marker 170. This identification marker 170 may be a set of electrical contacts, which can be accessed by the control logic within the device. In other embodiments, the identification marker may be a bar code, physical key, or other distinguishing characteristic.

For example, the storage element within the device may be used to store a plurality of songs, which are not all accessible with a single display card. Suppose that the storage element stores 60 media files, which are organized as 5 sets of 12 files. A particular display card 160 may have an identification marker 170, such as a key or readable mechanism. The control logic would determine the identity of the display card 160 based on this identification marker 170, and based on this determination, select one set of 12 songs to make accessible. The removal of that display card 160 and its replacement with a different display card may allow a different set of 12 songs to become accessible. In this way, the display cards are simple and low cost, while providing the user with additional functionality.

A method of installation for an interchangeable display card is shown in FIGS. 5C-5E. By loading the display card 160 into a slot 144 in the device 100 like a cartridge, the player is ready for use. Interchangeable display cards 160 provide users the ability to construct their own display cards and/or playlists. In some embodiments, the users may purchase new display cards and/or playlists as standard packages. The new card is then installed in the device 100 and the new playlist is available for playback. In another embodiment, the songs associated with a display card can be selected by the user, such as through an interactive software program used for populating a display card for use with the Touch Music Player.

Depending on whether a Touch Music Player is designed with a display card that is an integral part of the device or offered as an interchangeable feature designed to be changed out with or when the music is changed, there are several potential methods for having the cards or labels for the cards, buttons or players constructed. These methods include, but are not limited to
Printing/fabricating at the factory;
Printing/fabricating using specialty printers (primarily for in-store or reseller use); and
Printing on standard printers using label/sticker paper or transparency paper or specialty transparency paper (perforated edges or clear cut sheets with a support backing to peel off after printing, etc.) or some other means of populating a display not mentioned herein.

The Touch Music Player can feature a switch knob, alternate button set or some other means not mentioned for users to change song lists depending on the particular display card that they have loaded at the time. As described above, for display cards with additional functionality, a card can feature a notch that the Touch Music Player associates with a particular set of songs. A sensor with a barcode or some other readable mechanism can be used to associate the particular card with a particular set of music.

In another embodiment, the display card may include additional functionality, where the music is actually stored on the display card with a technology such as microSD cards. In this embodiment, the storage needed for the media files is part of the display card 160. This allows new songs to be made available to the user without costly upgrades or software updates. The new display card 160 is simply inserted into the device, as shown in FIGS. 5C through 5E.

In some embodiments, the Touch Music device 100 in FIGS. 5C through 5E may contain the actual button mechanism and illuminating features. In this embodiment, the Touch Card 160 includes button images 140 printed on a clear display window 143, such that the button images are aligned with the touch sensitive regions located on the Touch Music device 100. By pressing on the button images of the Touch Card 160, the underlying touch sensitive region, or button mechanism, on the Touch Music device 100 is actuated. The control logic communicates with the display card 160, such as by a connector 170, and plays the media files stored on the card. Therefore, when the display card 160 (also referred to as a Touch Music Card or Touch Card) is inserted like a cartridge into the Touch Music device 100, the stored material in the display card 160 is made available to the device 100. When a user presses one of the display buttons, the associated media file (or corresponding button function) starts. In other embodiments, instructions and other information may be contained on the display card. This allows the functionality of the device 100 to change, based on the display card that is installed. Combining a display card and a microSD card (or other memory device) into a single package provides an inexpensive means for limitless music with the Touch Music display and functionality on one device.

Interchangeable display cards or Touch Cards could also be configured in other ways, such as having the actual button mechanism or sensor and/or visual indicating features, such as lights, integrated into the interchangeable display. Some examples include a snap on or snap fit block with capability to transfer data content or a feature with which the accepting device can identify the snap in or snap fit part to execute the associated content already present on the accepting device.

The device accepting the interchangeable Touch Music display can be of a number of forms. These include configurations similar to boom box radios, MP3 players, home entertainment stereos, toys, computers, computer monitors, computer keyboards, computer mouse, game controllers, telephones, cell phones, telephone handsets, and remote controllers (where a consumer could buy a product requiring remote control capability and get a Touch Music product such as the interchangeable display along with it or separately).

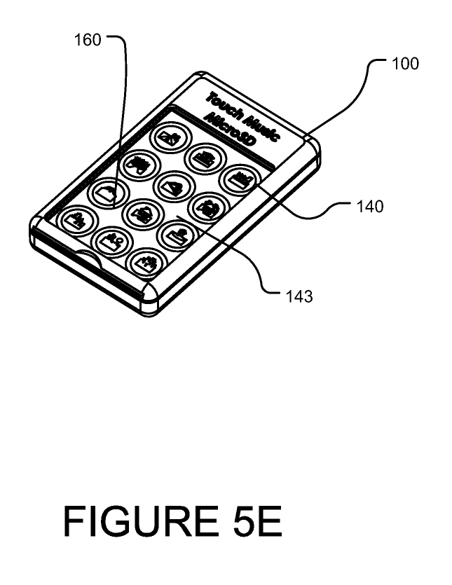

In another embodiment, the actual touch sensitive regions, such as the buttons, are interchangeable. FIGS. 6A-6F illustrate a possible Touch Music Button design. In this embodiment, the button 200 may be designed having an identification marker 210, as described above. In this embodiment, the control logic within the device recognizes the particular button 200 and associates a particular previously stored media file with this new button. In another embodiment, the media file is actually integral with the interchangeable button 200, allowing new media files to be added to the device. Additionally, the button 200 may include an illuminating feature 215. The illuminating feature is powered by the Touch Music Player when the Touch Music Button 200 has been installed into the device and the button is actuated to activate the content associated with the button. In other embodiments, the button 200 has a stored media file or both a stored media file and an illuminating feature. If the button 200 contains additional functionality, it may also have an electrical contact between itself and the device. In some embodiments, the marker 210 on the bottom of the button 200 may facilitate communication between the button and the device, such as via serial communication. In other embodiments, a plurality of contacts exist on the button 200, each of which provides communication to and from the device for a particular function (i.e. a contact specific to the illuminating feature, and a second for the file transfer).

Designing the Touch Music Player with interchangeable buttons 200 creates an even more interactive device while maintaining the simplicity and ease-of-use inherent in the nature of the Touch Music Player. An enormous collectibles market can be generated with interchangeable buttons.

In some embodiments, the device includes a housing having a plurality of openings, each of which is adapted to accommodate an interchangeable button 200. The button 200 may be designed to screw into the opening, snap in place, or be inserted by use of other means. In some embodiments, individual button labels; stickers; clear overlays that adhere to glass; inserts, clip-on, screw-in, or snap-on labels (or some other mechanism known in the art), or even the buttons themselves can be installed onto the device at individual locations to describe, represent, or depict the audio or software content of the specified key or button.

In some embodiments, the illuminating feature 215 is also integral to the interchangeable buttons (also referred to as Touch Music Buttons or Touch Buttons). In some embodiments, the Touch Music Button 200 is loaded with media content or executable files using a special docking station and/or connection to a computer. In some embodiments, the Touch Music Button 200 is labeled with any of the described methods herein. In some embodiments, the Touch Music Button 200 is purchased with pre-loaded song(s) or audio-clip(s) and/or label, sticker, etc. representing the audio content or software stored on that button. In some embodiments, customized Touch Music Buttons 200 can be designed and ordered using the corresponding computer software program. In some embodiments, only the labels, stickers, etc. are ordered and/or printed.

For any of these scenarios, a set of buttons 200 and a Touch Music Player can be sold as a package. This style of Touch Music device could also be configured to include games similar to those of Kidz Delight's Interactive Animal Cubes, where a small box with audio functionality gives directions such as “Find the rabbit”; the user then has to find the block with the rabbit on one of its sides and press the block into the audio box in the proper orientation for the audio box to acknowledge that the user did indeed find the rabbit. The Touch Music Player can be set up as an interactive puzzle for children, where buttons may have different shapes that lock into the Touch Music Player when inserted. Touch Music devices of this nature can be sold with separate button expansion sets where a Touch Music Player may have software, music, etc. already installed, capable of interacting with numerous button sets.

Interchangeable Touch Music Buttons 200, where the music is stored directly on the button itself, could also be sold separately from the Touch Music Player. FIGS. 6A and 6B illustrate a possible Touch Music Button design that contains both audio data and an illuminating feature. The illuminating feature is powered by the Touch Music Player when the Touch Music Button 200 has been installed into the device.

As shown in the sequence on FIGS. 6C-6F, the Touch Music Button 200 may be designed such that locking tabs 216 on the sides fold in when the Touch Music Button 200 is either pushed into a corresponding port or when the button is depressed. When installed in the Touch Music Player, pressing the button 200 activates the illuminating feature and starts the playback of the media file associated with the button. The signal to the player to start the music can be transmitted with an electrical signal through a port 210 in the bottom of the button or by the retraction of the locking tabs 216. The user can remove the Touch Music Button 200 by pulling up on the button using the two detents 217 on the top face while depressing the button to release the locking tabs 216. Another method to disengage the Touch Music Button could involve mechanisms at the detent location that the user can squeeze while pulling up on the Touch Music Button instead of having to depress the button as well. The particular method used to install and remove the buttons is not limited by the present disclosure and could include any other method known to those of ordinary skill in the art.

Pre-loaded individual music buttons can engender a huge collectibles market by offering users' favorite artist or band buttons, especially in limited edition models, and multiple displays and display types. Creating series of buttons for particular artists, music genres, billboard hits, television shows, etc. would influence users to buy additional buttons to complete a particular series.

Pre-loaded individual Touch Music Buttons also pave the way for a host of other products that feature ports designed to accept and play the content of the buttons. Some examples of toys include balls, disks, musical instruments, read along books, and musical books. A read along book could be sold with a Touch Music Button or set of Touch Music Buttons that users can install into their Touch Music Player to play as users read along with the button's audio content.

Touch Music Buttons can be custom ordered or custom fabricated as can be done with the various display card types described herein. Touch Music Buttons can be customized with a user chosen display and media content and/or an executable file or files or ordered as a standard component, where a display is readily available on a Touch Music Button with corresponding audio content. Blank Touch Music Buttons can be sold where users can insert or install their own display and media and/or executable file or files. Media content could be installed onto the button easily through a computer interface, either with the Touch Music Player or with a separate docking method.

Touch Music Button or Touch Buttons 200 can also be created for other capabilities, such as games and functions. Wearable buttons can be designed as jewelry for children. A Touch Music Bracelet or Necklace, for example, could be made so that the button(s) are not removable and the bracelet or necklace is only capable of supporting the music and display with which they were designed/fabricated. Removable or integrated Touch Music Buttons can be designed into practically any apparel items. Examples include shoelace attachments, shirts, belts, suspenders, bracelets, headbands, wristbands, armbands, pants, shorts, sunglasses, rings, earring clips, necklaces, pins, sashes, handbags, jackets, wallets, key chain links, gloves, and scarves, as well other apparel items not mentioned herein. The Touch Music Buttons could be designed into clothing such that the button is also functional for the apparel. For example, a shirt could be buttoned with Touch Music Buttons capable of fulfilling the required functionality of holding a shirt and cuffs closed.

In some embodiments of the present invention, a simple folder structure can be used to download audio content onto specified button locations of the Touch Music Player. A separate folder can be designated as an individual button's location, where a user can insert audio, video, or coded function content into each folder through Windows Explorer or some other browser. Users can drag-and-drop or copy and paste whatever content they want into the associated folder contained on the actual device.

An interactive computer software program, on-line interface, or other familiar interface means can be designed to load music, functions, software, or other digital data to particular buttons on the Touch Music Player, Card, or Button. The interactive software can also be designed to populate the button displays and/or background displays for a Touch Music Player, Card, or Button for fabrication as discussed herein.

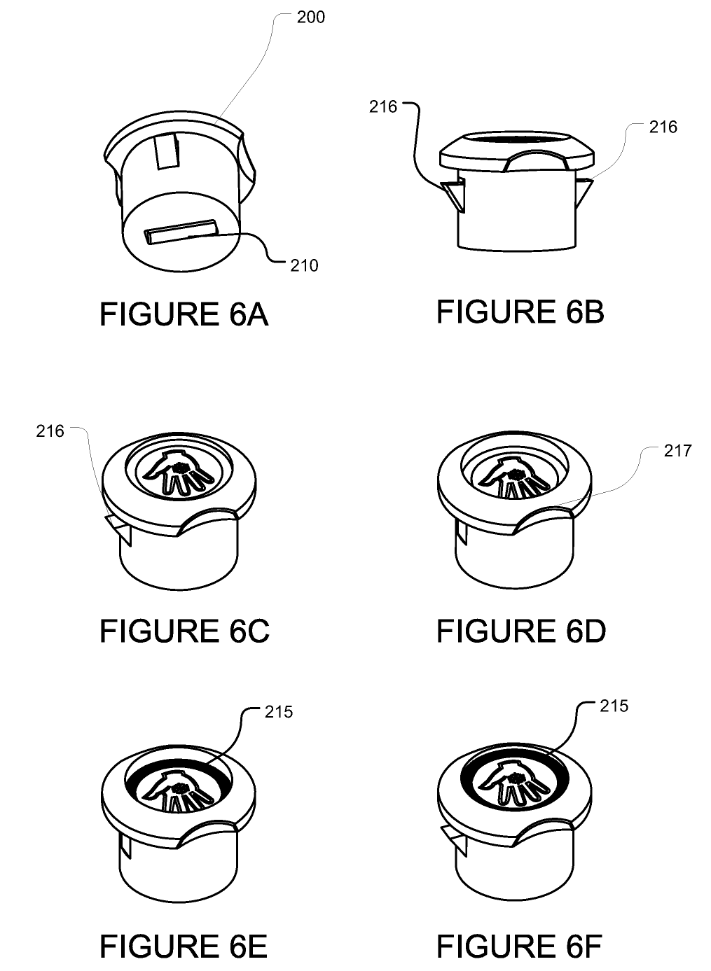

The interface 300 for one such interactive program is shown in FIG. 7. In this embodiment, the interface 300 includes a plurality of possible device background artwork 310. The user can select one of the designs from a list of available designs as the background of the display card. The interface 300 also includes a plurality of button display designs 320 from which the user can select. The interface 300 may also have a graphic 333 representing the device in graphic window 330. In some embodiments, the user can select a design from the button display menu 320 and “drag and drop” it to a specific button on the graphic 333. In addition, graphic window 330 may also include a list 335 of the buttons and the media file associated with each. Another menu 340 may include a list of media files that are available for download. These media files may be categorized according to artist, genre, alphabet, or using any other desired grouping. The user can then select a media file from this list and “drag and drop” it to a specific button to associate the media file with that button.

In some embodiments, the device includes functionality other than, or in addition to, the media files. For example, in some embodiments, the device may be used to play games, rather than play music. In this embodiment, the touch sensitive devices would be associated with particular functions or procedures. For example, a game may require “up”, “down”, “left”, and “right” buttons. The control logic can be programmed to allow each touch sensitive region to be associated with a particular function. In the interface 300, a menu of functions 350 is shown, which allows the user to select these functions. As described above, a function can then be associated with a button. The interface may include other features, such as allowing the user to select colors, fonts and font sizes, and other features.

As described above, the interactive computer software program, on-line interface, or other interface means may display an image of the Touch Music Player, Card, or Button that users can customize right on their screen. A user may drag-and-drop choices from a library of music, functions, button art, background art, etc. to populate the displayed image of the device. A simple click or double-click operation can be employed to move selections onto the first available location on the displayed device. Fully populated selections could be made available for users to modify to their liking, removing and adding the particular song or image choices they want.

As music, functions, data, etc. are dropped onto a button, the song name, function name, or some other indicator, such as illuminating the button to a certain color, could let the user know that the particular button has been populated. Full display cards can be made readily available, allowing users to open up a fully populated device and then modify it as they see fit. Modifications can easily be made by removing button displays and/or music with the delete key, or by dragging buttons to another location, causing a populated destination button to move to the next open location on the displayed device. As a user adds non-display content to the displayed player, the content could download to the device or be available for download where an actual player is available for configuration.

In some embodiments, the depicted Touch Music device in said corresponding computer software can be configured such that it operates similar to the actual device. Therefore, when a user clicks the mouse on a particular button, the audio content starts to play. Clicking on a different button starts the audio content stored under the newly selected button, and selecting the same button again stops the audio content. Using the computer, the button could become animated or a corresponding video file could play along with the audio content.

FIG. 7 shows a representative interactive software interface. A series of library windows can be opened and closed as users require access. The windows can contain a hierarchical arrangement of their contents so that users can find what they are looking for more easily. Some of the possible windows that can be made available to the user include background displays, button displays, music, functions, and packages. Search capabilities and help tools can also be featured directly in each of the windows or a new window can open that has additional capabilities for searching in a particular category.

It is also possible that customization tools can be made available so that users can design their own artistic displays or import their own pictures, music, or custom coded functions or games. In some embodiments, the software may include a scaling feature so users could adjust the size of their images to fit the Touch Music device display. In advanced software packages, the software can be used to modify images or even allow the user to create art through drawing or modeling capability.

In FIG. 7, a partially populated Touch Music device graphic 333 is featured in the graphic window 330. A particular background has been selected from the background displays window as have the text, text style, text font size, and text color. As a user makes the text changes, the depicted Touch Music Player automatically updates to display the changed settings. Therefore, if a user presses backspace to delete the last “c” in Touch Music, the display will also show the displayed title without the last c and only show Touch Musi.

In FIG. 7, six of the twelve button locations have already been populated and four of the twelve buttons have been assigned music (as indicated by the text to the right of the device). In some embodiments, the user can use the device graphic 333 as they would an actual device. Users simply click on a button, just as they would on an actual Touch Music Player, to start playing the corresponding song. Using the computer, the button may become animated or a corresponding video file could play in another window. A time bar can also be displayed to show the song's progress.

The interactive software may provide detailed information regarding each item in the library. Details about art or pictures may include artist/photographer, date created, picture/image name, image quality, additional background, etc. Detailed information for the music window may include artist, album, length of song, and genre. The functions window may feature functions such as mode, game, sound, passcode, and play capabilities. It may supply more detailed functions information, e.g. code developer's name, company (if applicable), date created, code title, and size. It may provide instructions on how to operate the Touch Music device. The packages window may provide detailed information regarding the product package, e.g. music, functions, button display, background display, text, hardware, device, or any combination of these. For example, a display package may include the button displays, background displays, and text; the detailed information may include the list of artists, text size and style.

Libraries, such as those for the display background 310 or the music menu 340, may include folder structures that users have created based on the materials (displays, music, functions, packages) they already own or items they can download in order to order or populate a device.

Some purposes of the interactive software include
Designing a custom template for a display card;
Saving customized arrangements;
Populating and downloading music and functions to a Touch Music Player;
Implementing advanced control features for the device; and
Customizing a device for purchase.

Another feature of the interactive software may be the ability to generate custom settings for the Touch Music Player. For Touch Music devices without video displays, providing users the ability to adjust some device settings with the interactive software is suggested. Parental controls can be managed with the interactive software, e.g. maximum/minimum volume or volume set/lock settings. Increasing the ability to configure the device's settings through the interactive software also reduces the need to have additional switches or controls on the actual device.

One setting type is the play mode, which can include settings such as continuous sequential play, continuous play at random, repeat play, and one song or button execution only. For continuous sequential play, the device can be configured through the interactive software to play each button's media in sequence for the maximum time programmed, or until the playlist is cycled through a predetermined number of times. For devices that have multiple media files per button or per button sets, the continuous play mode could be restricted to continuously playing only the media stored within the selected button or button set. The same functionality can be applied to a button, button set, or device for random play instead of continuous play.

The one song per button mode refers to the user pressing a single button causing the device to stop playing once the media content has completed for the selected button. For devices with multiple songs stored under a button or button set, the single song mode could be applied to play one media file and a user would have to press the same button again to play the next media file, unless the device were configured for repeat play, in which case the same song would repeat for the defined time limit or song number of plays limit if applicable.

A maximum play time setting can be made available in the interactive software so that a user can enter the maximum time length for which a device will play if there is no interaction with the device for a set length of time. For example, a user may decide that one hour maximum play time is reasonable to conserve batteries in the event the user forgets to turn the device off even if the device is set to a continuous play mode (or has extraordinarily long audio clips in a given button).

A system default can be provided in the interactive software so that users can reset any customizations or settings to the original format. The interactive software can also include additional control features such as passcode enable functions, settings control or setting controls through the device itself, and open source software programming capability.

After a device has been populated in the interactive software, a display card, button, or entire device can be fabricated through the various methods described herein.

With unlimited configurations available, interactive purchasing methods could be used both on-line (similar to configuring and purchasing personal computer) or in-store (similar to Build-a-Bear Workshop®, where customers can customize and “build” their desired product right then and there).

For on-line purchases, major categories could include hardware, music, functions, display, and standard packages. Customers could make their selections and view them by way of an on-screen depiction of the device that changes as customers make each selection. A drag-and-drop approach could be used with music, functions, display, and standard packages options, and possibly for some or all hardware options. Standard package deals or pre-designed configurations of Touch Music Player hardware, music, functions, and/or display could be available in the standard packages category. For example, a Hannah Montana collection of songs could be available with recommended music, background, and button displays. Users could select and drag-and-drop this particular package onto the depicted device. Customers could then move, change, add, or remove items until they achieve a desired product.

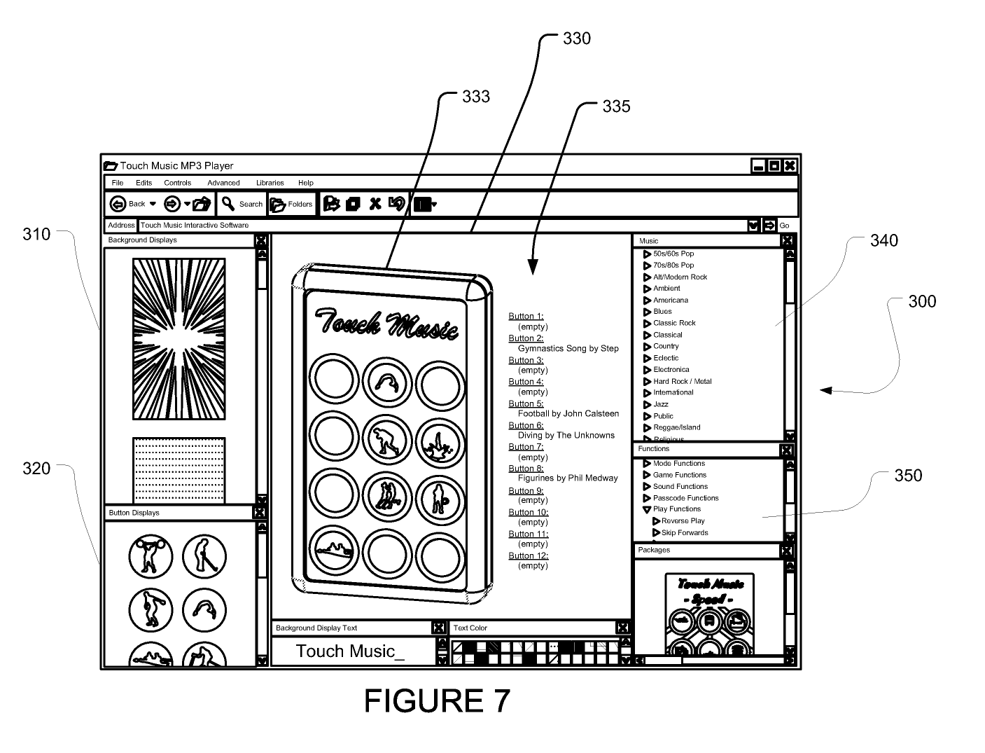

In FIG. 8, the hardware, music, functions, display, and packages tabs are shown directly above the on-screen depiction of the Touch Music Player. All tabs have been activated with the exception of the functions tab. In FIG. 8, the depicted Touch Music Player shows that the user has not yet selected a background display. The user may need to select a background and either double-click on it to populate the device or drag-and-drop a background display onto the device. As a user makes selections for purchasing a device, a card, or a button, a running tally of the prices of the Touch Music Player items may be displayed on-screen, such as in the upper right hand corner. In addition, the price of each song, display, function, interchangeable card, and interchangeable button that the customer selected can be shown, such as in the main display window or an individual window. In FIG. 8, the cost of the library items is displayed next to each corresponding item available to the user. Users are provided the option of purchasing just an art or button file or any individual items or arrangement to store in their personal library, from which they can print cards or button display items or download to their device(s).

Also shown in FIG. 8, nine buttons have been populated with displays but not music, except for the top right button which is active and playing a song. Assuming that this button is playing music the user is previewing, the music can be configured to allow only a 30-second preview of the song, a typical length of time allowed by other applications for previewing a song for potential purchase. In this example, as in the previous example for the interactive software, a populated song may be indicated by a dark ring around a song. A darker ring indicates that a song is playing; a lighter ring indicates that a song is populated on a particular button, but not currently playing. Other means to indicate or list songs can be used, including means to identify hidden tracks or songs that require two or more buttons to be pressed in order to play.

A web-site or software interface for defining and purchasing the device may also be configured such that users can submit their own background and button display through jpegs, bmps or some other compatible image files. Users can be provided the ability to populate a device, interchangeable card, or interchangeable button with music or software that they have created themselves or that they already own. Ideally, the same interactive software interface used for populating and purchasing a new Touch Music Player could be used for configuring a user's already purchased device, interchangeable cards, interchangeable buttons, functions, music, and display art. The software (on-line or installed) may require search capabilities, as well as the ability to interact or be integrated into a software package capable of executing such searches of displays, function libraries, and music libraries.

For the button displays and the background displays, actual art or photo images could be used; agreements with the owner of the art and/or images and/or the individual who is featured in a photo are necessary. Similar agreements are commonly addressed with record companies and music artists for the sale of music. In order to create a library of art and images for the button and background displays, options may include manufacturers creating the pictures or images, purchasing the pictures or images and reaching an agreement with whomever the images depict and/or the images' owners, or creating an open submission forum where the manufacturer allows users to submit images or art under a predetermined agreement. Such an agreement could include the compensation that the image's owner and who the image depicts would receive each time their particular image(s) are purchased by an end user. It is assumed that an individual button image would cost the end user less than the associated music. The button display and background display library could be configured such that an end user can search for images based on cost, with the expectation that some images are free while others may come at premium prices, depending on either the agreements in place, the demand for the images, the source of the images, or even based on limited edition images which will eventually be retired and no longer offered for sale.

In some cases, the image may be of a particular music artist associated with the user-selected music; any agreement that the manufacturer already has with the applicable record labels may be leveraged in generating financial/legal agreements for image use as well.

FIG. 8 also illustrates a second embodiment of the software interface. Many features are identical to those shown in FIG. 7. However, in this embodiment, the various designs, media files, etc. all have an associated cost, which is made visible on the interface. For example, a list of available options 380 is displayed. This list can change based on the type of device being purchased, i.e. a device with an integral display card, interchangeable display cards, interchangeable microSD style cards, interchangeable buttons, etc. A list of various hardware options is broken down into categories, allowing users to further customize their device to their needs. Some available hardware options and prices in the audio category are displayed. A running cost total 375 of the customized device may be made visible on the interface.

After defining the background display, button displays, music, or available standard functions for each available button and then completing a checkout/purchase, the items selected can be provided to the manufacturer, distribution center, or reseller where only the final steps of assembly and file loading are required. Then the device can be shipped or provided to the customer. In other scenarios, the customer may make a purchase and then download the music or functions or image(s). The display card image, button image, or labels can then be made available for the user to print. After customers configure their device, they can proceed through a standard on-line checkout/purchase procedure, where they would supply information to complete the transaction, such as method of payment and shipping information (if required).

As users move to purchase a device, the software could report an error which must be rectified before the order can be finalized, e.g. failure to populate a button or function content, or to indicate hardware choices, such as a battery type or means to deliver audio content (speakers, headphone jacks).

In-store purchases could be made using the same on-line interface or a specially made in-store interface, set of interfaces, or workstations geared for an enhanced in-store buying experience, such as at Build-a-Bear Workshop®. Customers could make their HARDWARE, MUSIC, FUNCTIONS, and DISPLAY selections, and then have their product built in-store. They may even be active participants in some of the assembly steps.

Another purchase option would be purchasing directly from a reseller, where consumers could bring a collection of their own music or a list of music and any art they want loaded in either a file format or actual hard copy for the reseller to scan. The user or store representative could then enter the user's music and display selections into the required software tool, or browse through libraries available in the store for music, functions, and background or button displays. Once all items have been identified and selected, the store representative or user could load the electronics and then print the display for the Touch Music Player, Card, or Button. The product can then be assembled as required.

Whether in-store or on-line, users can first be given the option of selecting whether they want a standard or custom product. A standard product is considered anything which is commercially available without modification. Standard products can feature devices with pre-loaded music and pre-defined button and background displays, e.g. a device featuring a single artist or band or some other categorized collection of music. A standard product can also feature a standard case with a USB port with music and buttons configurable using a software interface; it may have removable buttons or interchangeable display cards.

Devices with interchangeable music and a standard background and button display can be sold as standard products (in-store or on-line). Users would not need to purchase music or define other device options, since they could purchase and download what they wanted at a later date. Packages of almost any other versions of Touch Music products can be sold as standard products as well. Pre-packaged devices and/or cards or buttons featuring well known artists or popular collections can also be made available for standard purchases.

Standard Touch Players devices are pre-configured with battery type, speaker or headphone feature, volume control, etc. If the number of commercially available hardware options is significant, users can select their device through an interactive software program restricted by the available standard products available. An interactive program can be used in any case, and any customizations can be made to the product a buyer is attempting to build. However, a warning can occur if users select an option that is not featured in their chosen standard product. In such a case, customization can result in a cost increase or delay for the product's availability, which may be explained to the user within the interactive software.

Custom products can involve any variations in the Touch Music device described herein, including hardware, music/audio/video, button and background display, custom button definitions (hidden tracks, functions), and even game add-ons (Simon, Whack-a-Mole, Memory, Name that Tune, etc.).

Purchasing a device can also involve a systematic approach where users must define the make-up of their device. A first step could be to define the hardware configurations, a next step could involve the music and display options, and a further step could involve games and functions. Subsequent steps could involve the actual population of a device or purchase method details.

### Hardware Variations

A large number of hardware configurations could be made available for the Touch Music Player. These options can be categorized as product configuration, device control, audio, connectivity, display, battery, connector, recorder, and storage.

Product configuration options may include, but not be limited to, integral display cards, interchangeable display cards, interchangeable microSD (memory) cards, interchangeable buttons, interchangeable music buttons, video displays with buttons, touch screen device, application for touch screen-style device, and software for various products (computers, cell phones, video cameras, picture cameras, hand-held notebook devices, etc.).

Device control options may include, but not be limited to, button layout, number of buttons, on-board volume control, power on-off control, and miscellaneous additional controls.

Audio options may include, but not be limited to, on-board speaker(s) and head phone jack(s).

Connectivity options may include, but not be limited to, wireless communication capabilities, such as radio, cell phone, 3G (i.e. internet access), and remote control (remote controller for televisions, stereos, lighting, garage doors, home/car/business alarms, etc.).

Display options may include, but not be limited to, multi-colored button lights and a video display (including touch screen options).

Battery options may include, but not be limited to, disposable batteries (AA or AAA batteries, for example), removable battery pack (such as on a cordless phone) and an integrated battery pack (as found in most MP3 players).

Connector options may include, but not be limited to, a port for USB (for interchanging music/functions), a port for a recharging power cord, and a rechargeable power connection for mounting into a power charger base.

Recorder options may include, but not be limited to, microphone, video recorder, and a camera feature.

Storage options may include, but not be limited to, storage size (i.e. 100-MB, 500-MB, 1-GB, etc.), storage type (i.e. hard drive, flash memory, etc.), and file storage options (memory stick functionality).

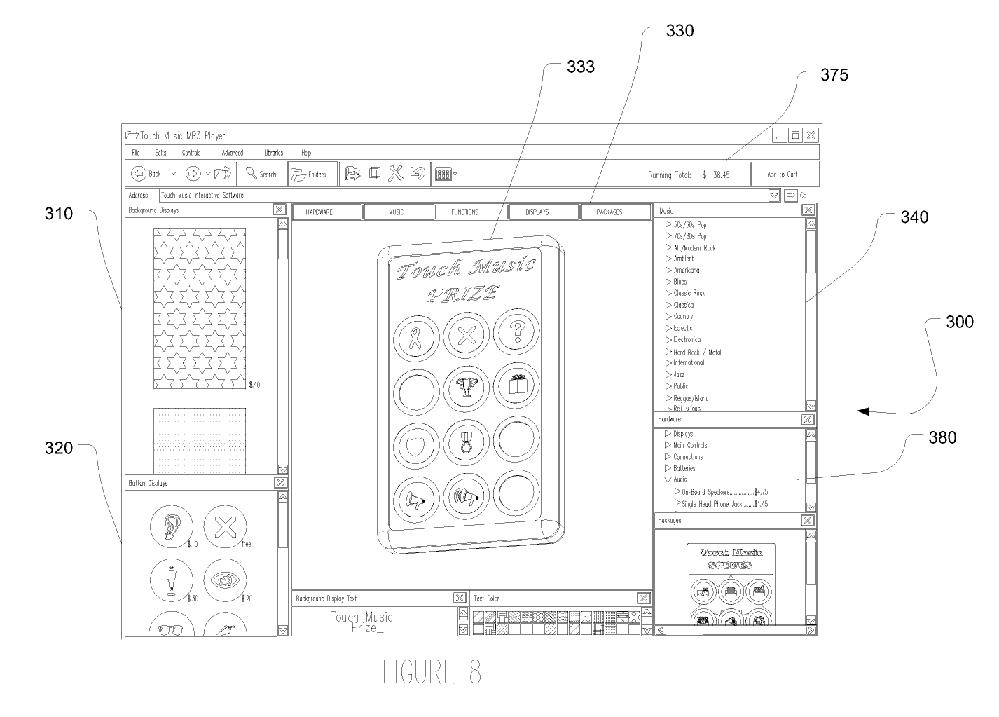

The hardware features can be incorporated into the base electronics package. Individual orders can determine the case design option. For example, if a user wants on-board speaker(s) but no headphones, a case with cutouts for the on-board speaker (or a case with a pre-mounted speaker) and no cutout for headphone jacks can be used at the product's final assembly stage. FIG. 9A shows a case 400 with a cutout 401 for a USB cable. FIG. 9B shows a case 400 with a cutout 402 for a power cord. In this embodiment, the only difference in the hardware configuration is the design of the back cover.

The consumer can custom order the Touch Music Player similar to the way one defines the options and features desired when ordering a computer. Certain hardware options available would determine the product to be purchased. For example, consumers wanting a fixed song list can select their music and arrangement of art to populate the background and define the music buttons; they would not require a USB port or means for changing the music on the device. Since a non-transferable music device includes the music along with the device, it may be possible to offer songs at a reduced cost. If the consumer purchases the Touch Music Player with factory-installed, non-transferable music, the device could potentially be distributed with lower song costs than buying a song online, since the latter is transferable and also more susceptible to piracy. A similar principle is used in selling licenses of other software products, where it is much less expensive to buy the software for a single machine rather than an individual software license that the user can transfer to an alternate computer.

In some embodiments of the present invention, the touch sensitive regions (i.e. buttons) of the Touch Music Player can be used to perform numerous operations. Rather than simply starting or stopping a song, a button or multiple buttons could perform a function or combination of functions. Some examples of functions that buttons can perform include fast forward, reverse, play faster/slower, play backwards, skip forward/backwards, bass up/down, treble up/down, scan, lock/unlock device (may include password by pressing buttons in a particular order and/or with a required speed), lock function, game mode, auto download/upload, volume up/down, mute, max volume, hidden track capability, continuous play mode, random play mode, specified arrangement of songs mode, alternate playlist mode, memory stick mode, custom function execution, start/stop audio record, start/stop video record, and other open-source custom functions that an individual user could design and assign.

An individual button can be configured to execute any number of described functions with a single push. An individual button can be configured to execute any derived function of the function examples already provided. If the button has an enable or disable function, the button could be illuminated while it is enabled and a song or audio clip is playing. Therefore, multiple buttons could be illuminated simultaneously, where one button could indicate the active song playing, while other illuminated buttons can be function buttons that are currently enabled. For example, a Touch Music Player with a reverse play function button can have its “play in reverse” function button illuminated, while a music button, also illuminated, is playing. Depending on the configuration of the device, function buttons can be arranged separately from music buttons, colored or displayed differently than music buttons, or even illuminated in different colors than music buttons. An example of another function is configuring a button to select an alternate playlist. When an alternate playlist button is enabled, the button can be illuminated and all music buttons would now play a different song when pressed than if the alternate playlist button had not been enabled.

The software code to execute the function associated with a function button could be easily downloadable to the Touch Music Player, just as music is. Function buttons can also have a visual display, just like standard buttons for audio content. As with one option for display cards, users could potentially design their own functions through an open source tool that is potentially integrated into the software interface.

Besides functions that are associated with a designated button, a function may be executed through the use of a passcode, where a sequence or arrangement of buttons could be pressed to execute a function. Function buttons can be used in place of some hardware variation features, e.g. volume control. A button with a + sign depicted on it for volume increase and a button with a − sign depicted on it for volume decrease can be displayed on a button instead of having a separate volume control feature installed on the device.

Devices with higher levels of customization also encourage the purchase of multiple devices, buttons, or cards in which functions have been built.

A set of function buttons can be used to change a device from its typical Touch Music configuration to a “Classic MP3 Mode”. A mode function button (or some other hardware switch) can be used to change the function of the Touch Music buttons so that the classic buttons standard on MP3 devices, such as play ( [symbol] ), skip forward (>>), skip backward (<<), pause (∥), and stop (▪), are available to the user. The display can also be switched or the classic MP3 symbols can be featured in conjunction with an alternate display feature. The classic MP3 display can be shown in an alternate color, in a smaller size, or displayed close to the button but not necessarily part of the button. These option types can be similar to a method used by calculators, which require that an alpha button or function button be pressed to have a button execute an alternate function, shown as a symbol or short description in close proximity to a button in the same text color as the alpha or function button. Similar methods can be employed with any of the function or mode sets of the Touch Music Player.

The Touch Music Player can be configured such that audio, video, or picture recording capabilities are incorporated into the functionality of the device. In this way, the Touch Music Player buttons can be set up to execute various record and playback functions. For example, users could select a button to which to record and then press a record button. When finished, they can press the record button and/or destination button to stop the recording. They can then play back the recording by pressing the button. In this mode, a plurality of buttons would be associated with media files; however, the media files would be recorded clips, as opposed to purchased or prerecorded songs.

With the customization capabilities for Touch Music, artists also have new levels of control over their audio content. Artists can redefine “album art” with a custom label or image design for each song. Not only are artists given the ability to create meaningful album art, labels, or pictures for each of their songs, they now have a limitless number of innovative functions they can incorporate into their albums. On CDs, for example, artists would sometimes put a hidden track at track 97; some vinyl records could be played backwards to listen to hidden content. Touch Music allows artists to incorporate hidden tracks by requiring multiple buttons. Artists can incorporate a display button used to turn on and off singers or instruments. Artists could use buttons to play songs faster, slower, or backwards. They could include musical transitions between songs. They can incorporate content such as games, trivia, and personal bios into their own personalized Touch Music card.

Function buttons could also be used to change the music style. Thus, a song could be switched between “Normal” and “Polka” modes, provided that a polka remix of the song is available. A language button could also be featured to switch between “English” and “Spanish,” for example.

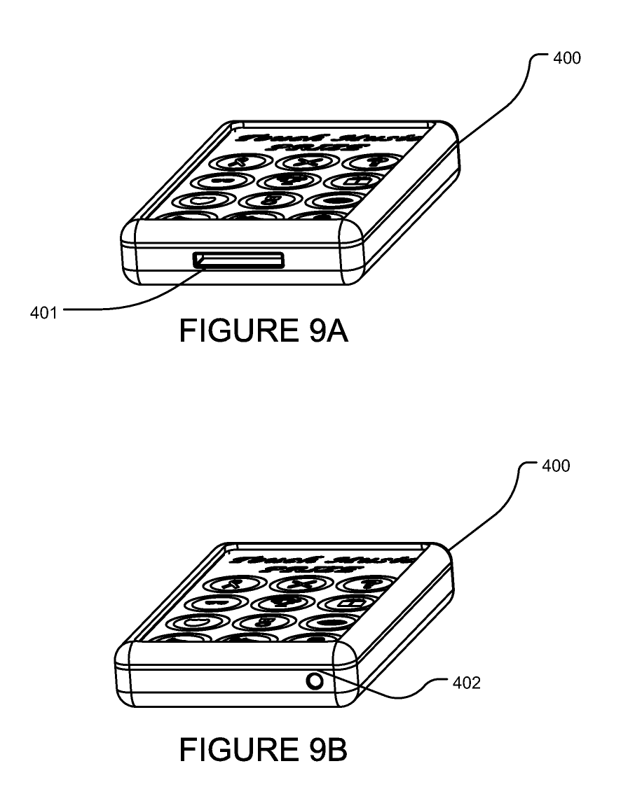

In addition to media files, a number of games can be integrated into the Touch Music Player and be accessed with a control switch or through the use of passcodes or function buttons. A display card 520 can be dedicated entirely for a game or set of games, as illustrated in FIG. 10 where three games 501, 502, and 503 are featured. In some embodiments, the display card 520 includes the display graphics, as well as executable files (i.e. the instructions for execution of the game or games depicted on the card). This allows new games or other executable applications to be added at a later time without the need to update the device.

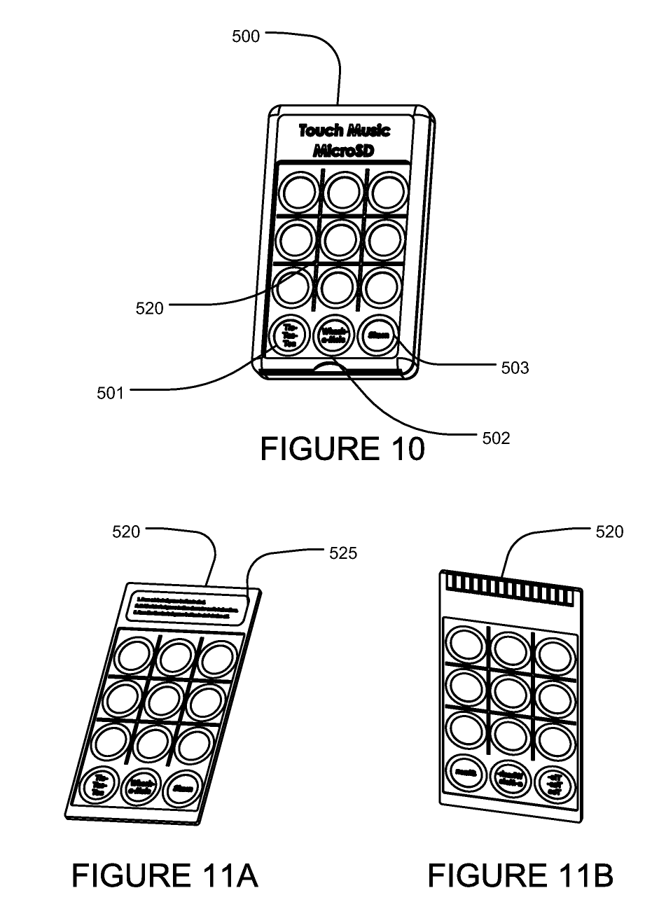

FIGS. 11A and 11B depict the front and back views of an interchangeable display card 520 with microSD style, or other, engagement. This interchangeable display card 520 has the same functions as shown in FIG. 10.

A label with instructions 525 for playing the associated game or games can be placed directly onto an interchangeable display card 520. In FIG. 11A, the provided instructions read as follows:
1. Press a labeled game button to start.
2. Hold a labeled game button down for audio instructions.
3. Press the illuminated game button to shut device off.

Below are some game examples that exploit the capabilities of the Touch Music Player:

Name that Tune—The device plays short bites of a song; user selects the button associated with the song bite. As user continues to select the correct buttons, the song bites could get progressively shorter to increase the challenge.
Tic-Tac-Toe—By making use of the multi-colored light feature generally used to indicate battery power level, different colored lights could distinguish between two players who take turns selecting buttons. A single user could play against the device, where the device is capable of making selections.
Connect 4—For a device with a greater number of buttons than the illustrations featured herein, users take turns selecting buttons in a designated top row. Lights illuminate down to a bottom row, representing chips falling into place. User could also select the button in the bottommost row available. Two different colored lights could distinguish two players, making use of the multi-colored light feature. A single user could play against the device, where the device is capable of making selections.
Simon—User memorizes the sequence displayed and then repeats the sequence by pressing illuminated buttons in the correct order. With Touch Music, Simon could be put to music, so user not only needs to memorize the sequence displayed but must press buttons in sufficiently close time sequence and/or for a sufficiently matched duration. The buttons could either be arbitrary or actually represent particular music notes so the sequence is intuitive based on expected notes.
Whack-a-Mole—When a light flashes, user quickly presses the illuminated button before it is no longer illuminated. The sequence of lights could speed up with shorter illumination durations as the game continues or for more advanced levels.
Battleship—The device could randomly select locations for the “ships” to hide or users could pre-select locations to hide their ships. A player could then select one button at a time in an attempt to strike a hit on a hidden ship. The buttons could illuminate one color, such as green to designate a missed location, and a second color, such as red to designate a hit. The game ends once all target locations have been hit. Two or more users could play, with each player taking a turn on a separate playing field; the device would switch to display the hits and misses that each user achieves in the search to sink ships.
Memory—User selects a button to display either a sequence of illuminations or a part of a song. User must then find the matching button which has a different piece of the same song, the same clip of the same song, or displays the same illuminating sequence as its matching button. All buttons could be illuminated or not illuminated as the game starts; then the lights would switch to the opposite state as correct selections are made. A flashing light feature could show when buttons have been selected and a multi-colored illuminating feature could distinguish between two players in a dual-player mode or when a user is playing against the device.

A significant number of additional games are possible with the availability of a video display or with the ability to connect to a television or computer or game console. The implementation of a video display in combination with the interchangeable displays in the cartridge-style format has the potential to lead to an entirely new line of handheld video games, video game products, and methods for playing games where users collect cards and multiple cards can be used in Touch Games.

In these embodiments, the control logic includes the logic necessary to perform the functions required by the particular game. For example, the software for a Tic-Tac-Toe game may include a routine to receive the user's input (i.e. the button or box that they wish to claim), a routine to validate the user's selection (i.e. make sure that the button isn't already assigned), a routine to acknowledge the user's selection (i.e. illuminating the selected button), a routine to select a button to counter the user's selection based on the rules of Tic-Tac-Toe, a routine to display the device's selection (i.e. illuminating the desired button in a different color), and a routine to recognize game completion (i.e. a tie or a win by one of the participants). These routines would be executed by the processing unit in the control logic and may be stored in a dedicated storage element or may be integral with the processing unit.

The present invention can be customized for particular applications and fads. For example, the hype surrounding the American Idol phenomenon has inspired varied merchandise ranging from books, posters, and t-shirts to party goods, light up guitars, and inflatable microphones. Although CDs and DVDs are available, there are no products that truly capture the essence of American Idol like Touch Music Players, Cards, or Buttons have the capability to do. An interchangeable display card, for example, could feature contestants and music from a particular season of American Idol. The device's background display could feature the American Idol logo and phantom male or female singer or the top artist for that particular season. A 12-button configuration could display a picture or artistic depiction of each of the top 12 artists for the corresponding button with song(s) that artist had sung during that season. The buttons could be organized in the order in which the artists placed during the season.

To further capture the spirit of the show, hidden track capability can be incorporated into an American Idol Touch Music Player, card, and/or button set. For example, the top 12 performance can be accessed by pressing the number 1 and number 12 buttons simultaneously (similar to some car stereos which allow a station to be stored on two adjacent buttons); the top 11 performance could be accessed by pressing the numbers 1 and 11 simultaneously, and so on. When this type of hidden track function is activated, illuminating rings could appear on each button of a featured artist, e.g. either illuminating all 8 artist buttons of a top 8 performance or illuminating just the light(s) of the current singer(s), creating a virtual Touch Music “light show”.

The Touch Music Player could highlight other popular aspects of American Idol. Hidden tracks could feature duets or performances by multiple singers that are not included in one of the top number of remaining contestants' performances. Other hidden tracks may include the artists who originally performed the song rather than the American Idol contestants.

Some methods to access the hidden tracks include
Pressing two or more buttons simultaneously or in quick succession.
Alternate mode button, providing a different playlist when enabled or when held down while a user presses a contestant button or set of buttons.
Pressing a button quickly two or more times in succession if multiple songs are available.
Pressing a button or set of buttons for an extended length of time.

These methods provide additional ways to switch to alternate playlists of songs, such as the original song artist rather than the American Idol contestant, or additional songs sung by a contestant during a season, or unlocking a top performance.

A series of judges' buttons could be fabricated that could add value to the sale of a Touch Music device. After a contestant button is pressed to play a song, a judge button could be pressed producing the judge's evaluation with audio or audio and video. For example, pressing a Simon Cowell button after a contestant performance could produce his actual evaluation of the particular contestant. The judgment could play automatically after a performance.

American Idol features its songs and video performances through iTunes. After a performance show, a downloadable song file and a downloadable video file are made available on iTunes for each individual performer. Additional Touch Music items could be made available for each artist's performances. For example, a hard-coded interchangeable button could be available for each contestant's performance such that a user would have the option to purchase an actual interchangeable button, or the display and music for such, instead of just the song or a video currently available through iTunes.

Additional interactive functionality can be added to a Touch Music device for specific applications, such as American Idol. For an American Idol group performance, the user could be given the ability to activate and deactivate the active singers from a group performance. By pressing an illuminated button to deactivate the button/contestant, the contestant's vocal would be removed from the performance. To add the contestant back in, the user could press that button again. The button could then remain illuminated for the remainder of the segment or the duration of the song and may or may not blink with the level of activity of that vocal performance.

Another possibility is that a user could turn off singers during a top group performance such that their voices could not be heard during the performance. Therefore, it would be possible for a user to turn off all of the artists such that there is no vocal to accompany the music, adding another layer of interactive capability.

In a continuous play mode or as additional buttons are pressed during a song, musical transitions could be implemented for switching from one song to another song. Users could select the songs they want at any time; the sequence in which they pressed buttons would determine the order in which songs play. Songs could also be transitioned mid-song when a user presses an alternative button where musical transitions are available either instantly or at set points of a given song. For set points within a given song, pressing a different song button could let the current song play until it hits the next transition point, and then the musical transition would start and lead into the next song. This capability could generate a seamless transition between songs.

Another method of interactivity would allow transitions between artists who sang the same song when they performed on American Idol. By pressing the button featuring a different artist's rendition of the song, users could switch to the other version at the same point in the song. The user could then switch between the two songs at will.

Below is a capability summary of a possible Touch Music product for American Idol content, although other capabilities not mentioned could also be employed:
# of Buttons: 12
Button Features: Each button features an image of a top 12 contestant for a given season of American Idol.
# of Songs Featured: 35+
Song Categories:
   Featured Contestant Performance (1 song for each of the 12 artist buttons)
   Original Artist Performance (same song performed by the original artist)
   Top Idol Contestants' Performances (11 total performances as shown on each weeks' show where one less artist is featured as the contestants are eliminated)
   Same Song Performances (alternate contestant performances for the same song)
Song Activation Methods: Featured Contestant Performances
   Press button to start a desired contestant's performance.
   Press same button twice to start an original artist's performance.
   Press two or more buttons simultaneously to start a top performance, with the lower contestant number pressed determining the performance number of the 11 possible performance choices.
   Press two buttons that feature artists who have performed the same song during an American Idol season to unlock the song. The device will randomly select which artist to feature by illuminating the appropriate button and having the alternative button illumination feature blink. The user can then select the blinking button to switch to the alternate artist at the same point in the song. The user can switch between artists throughout the duration of the song.
Additional Features: Illuminating lights encompassing only the active performers for a top group performance
   Musical and/or vocal transitions
   Games such as identifying the artist for a given song or active contestant during a given song

While this embodiment is described with respect to American Idol, the invention is not limited to this embodiment. For example, other reality TV shows, especially music-based shows, may also interact with the Touch Music Player and cross-market buttons, display cards, and other accessories. In addition, many of the functions described above are not specific to American Idol (or any TV show) and can be implemented on any Touch Music device.

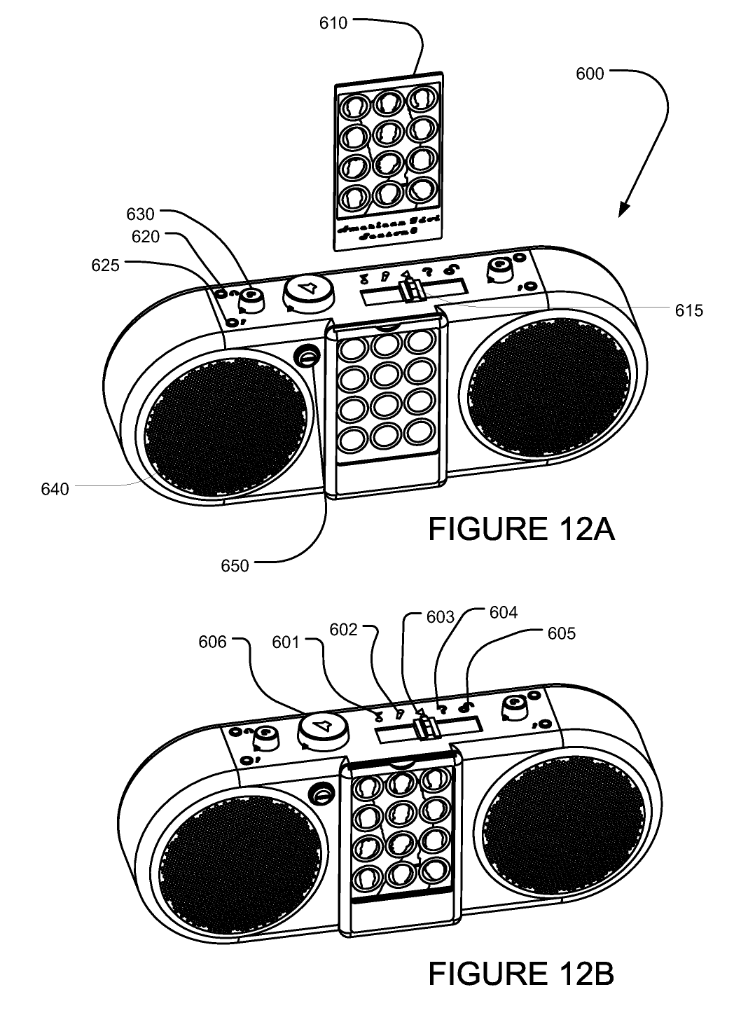

Other capabilities can be added to a Touch Music Player to further exploit the capabilities of Touch Music. By adding a “mode” switch to a Touch Music player, multiple music/play function sets can be achieved. FIGS. 12A and 12B depict an American Idol Touch Music Card 610 being installed into a Touch Music Player 600 with a mode switch 615 as well as other features such as microphone jacks 625 and headphone jacks 620. The headphone jacks 620 each may feature their own volume control 630. A volume control 606 for the on-board speakers 640 may also be available. A power button 650 is shown on the front face of the device 600 as well.

The five mode settings depicted in this embodiment include music (note symbol 601), record (microphone symbol 602), playback (triangle depiction 603), trivia (question mark label 604), and unlock (unlocked lock label 605) modes. The mode is changed by moving the slider 615 over to any of the five mode symbols.

The mode functions could execute as follows:
1. MUSIC—Standard play functionality. Pressing a button on the display card 610 starts a previously recorded song. Illuminating feature can be used to indicate the active song. Pressing a different button starts a new song. Pressing the same button stops the current song.
2. RECORD—Records the users' lyrics to the active song button.
3. PLAYBACK—Plays back last recorded song associated with the button pressed.
4. TRIVIA—Poses audio questions and sound clips to identify by pressing the correct button(s).
5. UNLOCK—Unlocks unique capability for the installed Touch Card.

For the American Idol Touch Card illustrated in FIGS. 12A and 12B, the mode buttons could function as follows:
1. Music—Plays top songs for each artist during the season by pressing the depicted artist buttons.
2. Record—Pressing a contestant's button causes the illuminating light to flash on and off for the duration of the song and plays music without their vocal. Pressing the button again includes the artist's vocal and illuminates the button (no flashing). Records user's vocal to the target song button available for play in Playback mode.
3. Playback—Press a button to illuminate it and play back the last vocal recording associated with the particular button.
4. Trivia—Poses audio questions regarding the depicted contestants' and plays song clips that the user must associate with the correct contestant button(s).
5. Unlock—Top 10 performances. Click on the contestant that finished in 8^{th} place to get the top 8 performance and so on. Lights illuminate for the contestants actively singing, producing a virtual “light show.” Shut off contestant voices by pressing their buttons during a performance.

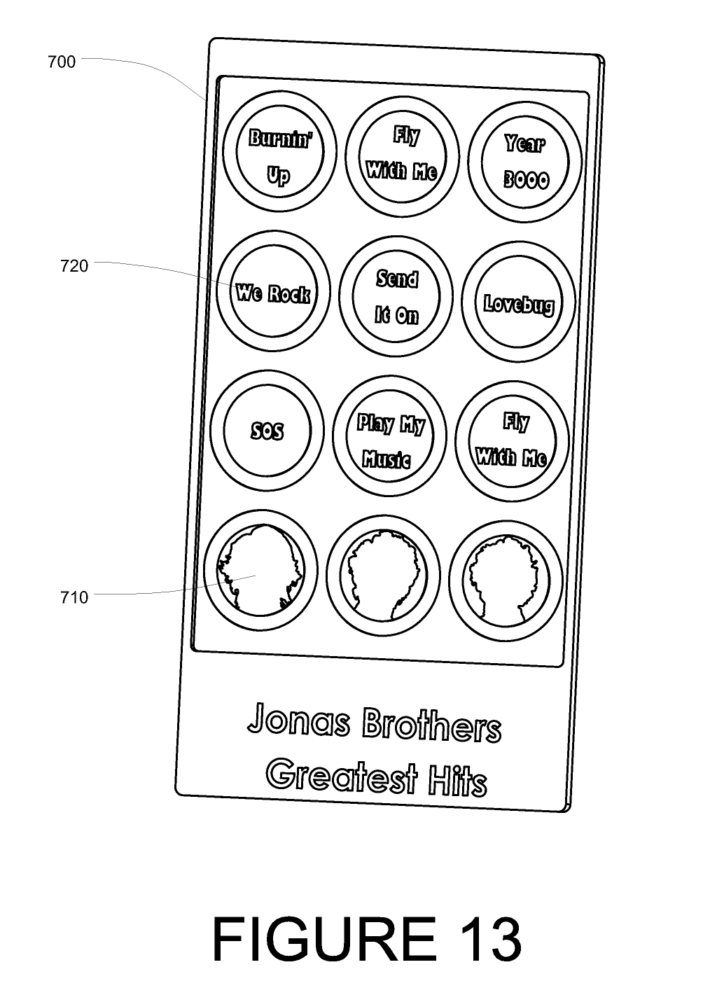

A Jonas Brothers Touch Card 700, as illustrated in FIG. 13, could feature a button display 710 depicting each of the three artists; the remainder of the button displays 720 could provide a meaningful image or label corresponding to their individual songs. As a song plays and the corresponding song button is illuminated, the user can turn on or off the various artist buttons (illuminate or de-illuminate their buttons). The mode buttons for a Jonas Brothers Touch Card could function as follows:
1. Music—Plays songs depicted on each of the music buttons. Hidden tracks built in by pressing two buttons associated with the “hidden” songs. Press the artist buttons to turn on or off each of their vocals.
2. Record—Press a music button to play music. Press the artist buttons to turn on or off each of their vocals. Records user's vocal to the target song button available for play in Playback mode.
3. Playback—Press a music button to illuminate it and playback the last vocal recording associated with the particular button.
4. Trivia—Plays audio clips of artists and songs; the user has to identify the correct Jonas Brother and/or song button that relate to the played clip. Also, asks various questions about the songs and the individual Jonas Brother that the user must answer by pressing the correct button.
5. Unlock—Jonas Brothers Rock the Beat. Plays the artists' music and lights the buttons that the user must press in time to the music.

With Touch Cards, children have personalized controls for their karaoke sound tracks. Unlike music cartridges/cards for other toys, the Touch Card provides new capabilities to children never before offered.

Whether the Jonas Brothers, Hannah Montana, SpongeBob, Diego, or Dora the Explorer, each Touch Card can feature unique capabilities to which children can relate. Capabilities that are best suited for the particular artist or artists can be featured on each card.

In addition to the modes shown in FIGS. 12A and 12B, the Touch Player slider settings could be broken down further. Mode settings could include player off, play music, continuous play, name that tune, trivia, karaoke mode, karaoke record mode, karaoke playback mode, and unlock capability.

The “play music” setting would operate like a standard Touch Music product, allowing users to switch between songs and turn off and on depicted artists, for example.

The “continuous play” setting would allow the player to switch to a next or randomly selected song and illuminate the corresponding button or buttons rather than stop after a single song is selected.

The “name that tune” setting could give a brief instruction on how to play and randomly play clips stored in the song buttons. The user would have to press the song button associated with the song clip. The “trivia” setting could ask questions that require the user to press the button or buttons that best answers the posed questions. The “unlock capability” mode allows a capability that is customized to that particular card. This mode could play all songs in another language (if available), create a light show for the artists' music, produce personal bio or song information, or even unlock a game capability.

The “karaoke mode” button would allow children to sing along with their favorite songs while having the ability to execute functions available through the specific Touch Card, such as turning artists on and off. The “karaoke record mode” setting allows users to record to the song button(s) that are currently playing, then play back when the users select the “karaoke playback” mode and presses the button to which their audio was recorded.

An audio output jack or multiple audio output jacks could be made available on the Touch Player so that the child singing the song has the ability to hear the original artist even when the artists' voice cannot be heard through the speakers. A microphone jack or multiple microphone jacks or microphone(s) that operate(s) with the Touch Player would allow the child's vocal to play through the speakers while the artist's voice plays through the headphones. With Touch Music capability, the artist or artists singing the song could be turned off by pressing the button image to de-illuminate that button or a button representing the vocal or vocals. In this way, the child can switch between singing with the artist, without the artist, or with some of the artists if multiple vocals are available for the playing song.

An enormous amount of capabilities can be incorporated into each Touch Card as described by the various capabilities of Touch Music described herein. Hidden tracks, light displays, games, passcodes, instrumentals, alternate song modes, speed controls, and trivia are some of the features that can be uniquely developed to best fit a collection of music provided on a Touch Card. This functionality can be provided by including a storage device on the display card. The storage element may contain media files associated with the various buttons. In addition, it may include instructions, which describe the extra functionality, which can be executed by the control logic in the device 600. These instructions may be executed directly from the display card, or may be copied to the device 600 and executed locally by the control logic.

A Touch Card, Player, or Button could even be designed so that a user's or users' own lyrics recorded with a song could be used to create new Touch Music products. Children could record their own songs and then connect the Touch Player or Touch Card to a computer or some other interface means to order or generate their own Touch Music Player, Card, or Button with their own pictures or desired images assigned to the music they recorded.

Touch Cards (or Buttons and Players) could also feature a switch mechanism or hardware feature to prevent writing data to the card similar to those in cassette tapes and old 3½″ computer floppy disks. This would give someone the ability to protect their Touch product so that his or her vocal wouldn't get overwritten if a user accidently started to play a song in “record” mode.

The present invention can also be designed to allow the users to provide applications that operate on the device. Promoting even more versatility, the Touch Music Player can be offered with open source software coding, thus allowing users to create their own games, light and sound shows, customized security features, new function buttons, playlist arrangements, parental controls, custom player settings, etc.

The custom coding capability can be offered in an advanced user menu within the interactive software. Also appealing to some consumers may be the opportunity to use the interactive software to design their own functions or games, and then submit their ideas for evaluation and possible sale to the company producing the Touch Music Player. The company selling the user's code can develop a software developer contract with payment terms. In some embodiments, the agreement would specify the financial compensation to the software developers for each time their software is sold or downloaded, although alternative agreement types are possible.

Some examples of how programmers could use this capability include
Creating certain play sequences or cut in new lyrics.
Mixing-and-matching portions of audio clips.
Illuminating different arrangements of buttons in various patterns or sequences.
Playing multiple audio clips simultaneously.
Developing code for games or other interactive capability, such as an audio calculator where a user presses numbers and calculator functions and the device repeats the entered values and then provides the calculated solution with a verbal response.
Creating “treasure hunt” games with audio messages provided for players to find clues and unlock new audio clips with instructions for locating subsequent clues.
Developing custom passwords (certain button sequences, simultaneous buttons, pressed button durations, etc.) to unleash secret bonus material (songs, code, etc.).

Any custom code descriptions could be provided with the device, downloadable separately from the device, or sold separately from the device. Using the interactive software, custom code functions could be downloaded to a user's Touch Music device just as audio or function content can be. Custom code functions could also be added to an order package where users must upload their software code to enable the manufacturer to download it for fabricating a device.

A separate “Add-ons” window can be made available so that users can identify the buttons they wish to associate with a function, song, etc. As users make selections, the interactive software can prompt them to indicate the buttons to which they want to associate the audio, video, code, or function.

For hidden tracks or other items requiring the use of two adjacent Touch Music buttons, the interactive software can be configured such that a user can drag-and-drop an item between two buttons rather than onto a single button. The same procedure can be performed with a row or column of buttons where there is a marker location displayed onto which to drop or move a file to the start or end of a column or row. The entire column or row would be highlighted, indicating that all buttons in a particular column or row need to be used to activate the particular function, song, code, etc.

The “add-ons” box or window in the interactive software can also feature any associated costs, details concerning the code or function, and details on how to execute the code or function. The additional functions, code, tracks, etc. can be displayed in a list of the device's content, which includes the content of each individual button as well. Such a list can be displayed in the same window as the Touch Music depiction. The following is an example of a list displayed in the interactive software:

| | |
|---|---|
| Button 1: | Song A |
| Button 2: | Song B |
| Button 3: | Song C |
| Button 4: | Function W |
| Button 5: | Song D |
| Button 6: | Song E |
| Button 7: | Song F |
| Button 8: | (empty) |
| Button 9: | Song G |
| Button 10: | Song H |
| Button 11: | Song J |
| Button 12: | Mode R |
| Buttons 1&5: | Song K |
| Buttons 1&9: | Song L |
| Buttons 4&5&11: | Song M |
| Buttons 7 →4→7: | Game Q |
| Buttons 11 → 2 → 4 → 9 → 4: | Passcode Z |
| Buttons 4&1 → 2&7 → 4 → 9 → 4: | Passcode Y |

In this example, an “&” symbol indicates that a user must press buttons simultaneously and a “→” symbol indicates that a user must press buttons sequentially. Therefore, to unlock the code, function, or audio clip behind Passcode Y, a user must press 4 and 1 together, followed by 2 and 7 together, then press 4, then 9, and then 4 again.

This example shows that 12 songs are available to the user, as well as one game, one function, one mode and two passcodes. By pressing the identified regions, the user can actuate any of these options.

The Touch Music Player has the potential to serve in many ways not yet described. Its hallmarked ease-of-use lends itself to numerous applications for both the technology-challenged and the adept user. Individuals can create and/or purchase/order customized devices that are so extraordinarily easy to use that even non-tech savvy individuals will quickly lose their apprehension. Similar to the ways in which customers can purchase Touch Music Players in-store or online, users could have in-store attendants customize devices for them; users more comfortable with technology could employ interactive software, either in-store or through their own personal computers. Additional applications of the Touch Music device could include, but are not limited to, any of the following:

### Data Storage:

Touch Music's functionality is ideal for storing critical data. Passcodes can be entered via the built-in keypad for access to encrypted data. The device can be configured as a USB device where users can program a specific password that can be used to open hidden folders. To access Touch Music content, the device can also be set up such that buttons must be pressed in sequence, simultaneously, at set instances, or in response to device prompts by sound or visual indication or some combination thereof. The device can also be configured such that it does not become active unless a certain arrangement of buttons is pressed to activate it, providing device security. A user may want system default capability, enabling a user to erase all content and reprogram the device. Upon pressing the proper passcode, the contents of the device become available. In some embodiments, the device has a USB port which allows its attachment to a PC, where it appears as any USB memory device. In this embodiment, the control logic manages the file system and allows access to certain files based on passcode entry.

### Integration of Touch Music Capability and Other Technology:

The ease-of-use and intuitiveness of the Touch Music Player can be incorporated into existing products with the introduction of a Touch Music Mode. It is possible to incorporate Touch Music Player functionality into new cell phones (non-touch screen style), home phones, or other multi-buttoned style devices. Tremendous proliferation is possible with the incorporation of Touch Music Player capabilities into toys and books.

### Digital Picture Frames/Video Players

Another means for changing the device's display could employ a video-style display to feature a picture or video file dependent on the active button or buttons. The buttons could be featured around the perimeter of the video display, along the display's outside edge or edges, or located elsewhere on the device. The buttons could illuminate or provide another visual indication, such as on the video display itself, as to which button or buttons are active for the depicted image. For example, if buttons are located around the edge or edges outside of the video display, an arrow, bar, or some other visual indicator on the video display located close to the active button could indicate that the designated button or buttons are currently active. The device's buttons could also be labeled or numbered so that when a user presses a button, the associated label or number is displayed in the display screen. This type of functionality permits numerous applications besides music buttons. It is also ideal for personal pictures, video files, camera and video recording, etc. so that a user can associate a single button with a picture or picture set presentation. In this embodiment, the storage element is used to store the media files, and to properly display them, based on touch inputs.

### Remote Control:

The Touch Music Player, Card, or Button could be designed as a remote control device for any applications requiring remote controls (entertainment systems, ceiling fans, lighting, garage doors, etc.).

Simple button setups, such as a “Watch Cable” button, could select the correct device mode for the television and change the entertainment center and cable box to the appropriate settings. With a “Watch DVD” button, the television's mode or channel could be changed, as could other peripheral equipment in the user's entertainment. A “Listen to Radio” button or “Listen to CD Player” could feature similar functionalities. Televisions could come with their own Touch Buttons, for example, that get installed into a Touch Controller that the user can press, enabling the remote for all of that devices functions.

Users could bring the list of devices they have connected in their entertainment center to a store; an attendant could create the necessary Touch Music or Interchangeable Touch Music Remote Display Card or Touch Music software configuration that will satisfy their home entertainment needs.

### Aid for the Vision Impaired:

People who experience difficulty seeing small buttons and using complicated devices could be helped by the Touch Music device's bright illuminating lights, illustrated button labels, and ease-of-use. These features would be of benefit in many of the device's applications, e.g. music player, remote control, audio calculator, and audio books.

### Audio Books:

The Touch Music device would be especially useful to play audio books. Its easy-to-see buttons could be made available for options such as volume, speed, etc. A bookmark feature could allow users to save their place or select a spot of an audio book, song, text file, video, recording, etc. to a particular button. The button could then be pressed at a later time to start from the saved location.

The bookmark function could also be enabled to save an excerpt to a button. The user could enable the button feature at the start of the target excerpt by pressing the target button to start recording, illuminating the recording button, and then stop the recording at the end of the target excerpt by pressing the button again, de-illuminating the button. Additional excerpts could be saved to the same or other button(s), allowing the user to press the button at a future time to play the excerpt(s). Bookmarking or recording excerpts to a button could be performed by various methods, such as first putting the device into a bookmark or bookmark excerpt mode or defining the start and end of an excerpt with actual text, an actual timeframe, or page or chapter specifications. Similar excerpts could be created for music, videos, recordings, text, location zoomed or targeted in a picture, sets of pictures, or any other portion or portions of digitally available media.

### Touch Toys:

Interchangeable Touch Cards and even Touch Music Buttons could be used in a variety of toys. For example, a Touch Card could be used with a Touch Music Instrument. A Touch Music Instrument could be a keyboard, drum set, saxophone, guitar, or some other instrument. A child could install the card or button into the instrument and have some of the same functionalities as with the Touch Player. A keyboard, for example, could allow a child to shut off the piano background so that he or she can be the piano player accompanying the music. The child could play any keys. Alternatively, the keys could light up to indicate which keys play the song's notes.

Other toys such as Touch Music Phone toys could allow children to have mock conversations with the artists depicted on the phone. The child could press The Campfire Song Song button and have SpongeBob talk about that song (with the music on or off). The child could select various song, artist, and image buttons, changing the nature of the “conversation.”

Touch Cards could also have designation labels to indicate with which toys they are compatible. Thus, a Hannah Montana Touch Card might operate with the guitar toy, the phone toy, and a karaoke toy; a small label with the 3 items could be displayed on the card to inform the user of the devices for which the card is uniquely configured. For example, if the Touch Card works with the Touch Play Phone, the Touch Karaoke Toy, and the Touch Guitar, a symbol of a phone, microphone, and guitar could be depicted on the card.

For compatibility between a Touch Player and a Touch Guitar, a Jonas Brothers Touch Card might show one of the Jonas Brothers holding a guitar. When the Touch Card is installed in the guitar, the child could stop the guitar playing by shutting off the Jonas Brothers guitarist's button; the child could then perform as the guitarist. When the card is installed in the Touch Player, the child could turn off a particular Jonas Brothers member's vocal by depressing that singer's button and sing his or her own rendition.

The potential exists to sync several instruments/players together, effectively creating a child play band. Synced devices also provide capability for competitions in gaming, trivia, name that tune, and play modes, as well as other games not mentioned.

### Applications Beyond Music

Touch Music Players, Cards, and Buttons can extend well beyond music. The interchangeable Touch Card could become the 21^{st} century baseball card: a digitalized baseball card-like collectible. The interchangeable display card could have button functions, music, etc. and could be setup for single picture/display like on baseball cards.

Standard baseball cards, or other collectible items, could even be encased by a Touch style card with digital information for the card or item and a means to protect and contain the card or collection item. A Touch Card could be used to store all of a player's stat information, years played, personal bio, awards, top play video clips, etc. It could also be used for game purposes.

A user could collect game cards to create their own team, army, group, etc. and use them to compete against opponents or a computer or for some other game means. The cards could even be parts of a car or body armor items or weapons that game players collect to make their own game player or team stronger and more competitive. Thus, digital cards could be used for playing games such as Magic the Gathering. Battles could be waged using a game module that accepts the cards.

A means to authenticate the card could be incorporated. Also, a designated location on the Touch Card could be created for autographs.

Touch Players, Cards, and Buttons could be generated for non-music shows featuring contestants or teams, such as Survivor or Amazing Race. The device's functionality could be extended for movie characters, sports teams, sports leagues, countries, historical characters, video game characters, or even a user's own defined templates for friends, families, businesses, pets, etc. The potential for proliferation is endless.

### Touch Screen Devices and Applications

The Touch Music Player can be fabricated as a touch screen-style media player device, created as the primary or default mode of a touch screen-style media player device, or even incorporated into an application that can be sold through iTunes or a similar on-line distribution site for use on touch screen-style media player devices, such as the iPhone, iPod Touch, Blackberry, etc. An Apple App, or some other platform of touch screen technology products that companies such as Microsoft, Google, Nokia, Palm Inc., and Research In Motion Ltd. have or will have, could be designed with the features of a hard-coded Touch Music Player described herein.

Considerable functionality could be incorporated based on the many features of products such as the iPhone and iPod Touch. Additional functionality could include animated buttons, animated displays, switching to different displays by sliding a finger, rotating buttons with an accelerometer, extravagant button light-up capabilities, additional game and trivia capabilities, shaking the device to shuffle or change the displayed buttons, editable switching and customizing button and background displays, song or button prioritizations, and others not named herein. Customized button designs, phone functionality, search functions, purchasing, accessing linked objects, taking photos for button and background displays, and streaming on-line content such as music and video are just a few of the advanced functionality topics that can be incorporated into a touch screen-style Touch Music device or an application for products such as the iPhone and iPod Touch. Many of the features described for touch screen-style devices can be incorporated into other embodiments of the present invention described herein as hardware and software constraints permit or the features could be included in derivations of the various embodiments described herein.

One significant capability of a Touch Music App is that it could be designed to boost sales of music significantly. By creating a Touch Music App for music, record companies would have another means of enticing users to purchase music. A Touch Music App allows users to do more with their music than simply listen to it. It gives them the ability to display it, interact with it, and play with it.

### Social Networking, Teleconferencing, and Phone Capability

Microsoft's MP3 player Zune was designed for social networking purposes with the ability to transfer music and video files from one device to another where the recipient would be allowed to temporarily use the transferred content with the option to purchase. The Touch Music phone capability discussed herein can truly capture the social networking market that Microsoft's Zune failed to secure. The Touch Music phone capability could allow users to easily call their friends, add or remove callers, see who is currently on the line, answer additional calls, and place a caller on hold. In addition, the device can record, stream in audio background, send music and files, stream audio and video content, etc. The Touch Music functionality could also offer a highly differentiated means for business teleconferencing purposes.

To populate a button with a photo, a photo button could be available for the user to press. The device could then be configured such that users can point the camera feature of their device, press the button they want to populate, actually taking the picture and populating the button simultaneously.

Thus, for phone call functionality, once a user places a call for one of the displayed buttons, the functionality of adding callers could be performed by pressing an additional button, an “add caller” button, or the “phone” button again and then the button that they wish to add. Users could continue to place calls and add callers to the line as often as desired provided their phone service can accommodate the number of joined callers. The user display would then show the buttons currently on-line with a visual indication of activity, such as illumination.

A conference call button could automatically call a list of people where an automated message can indicate that the parties called are requested to participate in a conference call. The participants can then be entered directly into the group call or the automated message could instruct the participant to hold until the host adds them to the group call.

To disconnect calls, the user could press an illuminated button to disconnect that particular person or the phone button followed by an illuminated button or buttons to disconnect those calls. Other functions could be made available to the user, such as muting certain buttons from the group, providing music to buttons on hold, turning the volume up or down for certain buttons, forwarding messages or pictures or some other items, etc.

The host of the teleconferencing function would essentially have control of the phone conversations similar to that of a radio station host when callers call in. The host can turn the volume down or shut off a caller's voice so that the host (or any other participants) cannot hear the caller but he or she can hear the host and any non-muted participants.

Another useful functionality could involve the device's management of multiple side conversations. If the host wanted two or more participants to discuss certain topics among themselves, the host could group particular buttons together so that only the grouped buttons hear each other while other groups only hear callers in their group. For a touch screen-style device, buttons could be grouped by selecting two buttons and pinching them together so they merge into one button in an elongated or larger button, or with some other visual indication to show that buttons are now grouped. Buttons could be dragged into groups, then one finger could select a group, a different finger could select another button or group, and then the two fingers could combine all the selected buttons and/or groups into one. Similar methods could be used to separate groups, e.g. a button could be dragged out of a group with one finger or one finger could be used to hold the group in place while another finger is used to remove a particular button or set of buttons from a group.

An indication feature could be provided to enable the host to see which contacts had been tried but not reached. A button availability feature commonly used for on-line chatting could be provided. When users are on-line on a computer, many programs, e.g. Facebook and Lotus Notes, provide an indication as to when their acquaintances are active. An active on-line status could be made available for Touch Music owners whose contacts run the same device/application for contact via text or by phone.

Button displays could be given a primary or secondary functionality as numbers on a phone. If a user wants to place a standard call, the displayed buttons (up to 10 buttons) could have a number associated with it, enabling a user to type in a phone number to save to a button or use this functionality to dial out as needed.

It should be noted that the present invention is not restricted to the embodiments discussed herein. Any combination or derivative of the described embodiments also falls under the protection of the present invention.

1. A device for media playback comprising:
an insertable card comprising a display window having a plurality of button images, and a storage element comprising a plurality of media files, wherein each media file is associated with one or more of said plurality of button images, and
a housing containing control logic in communication with said insertable card, said housing featuring a plurality of touch sensitive regions wherein said button images of said display window of said insertable card is positioned to overlay said touch sensitive region such that actuation of said touch sensitive regions causes the commencement of said media file associated with said actuated touch sensitive region, such that the replacement of said insertable card causes different media files to be available to said device.

2. The device of claim 1, wherein said housing comprises an illuminating feature corresponding to each of said plurality of button images, such that the illuminating feature associated with said actuated touch sensitive region is activated, said display window of said insertable card aligned with one or more of said illuminating features, such that said illuminating feature shows through the display window of said insertable card.

3. The device of claim 1, wherein a plurality of media files is associated with each touch sensitive region.

4. The device of claim 1, wherein said storage element further comprises instructions executable by said control logic, such that insertion of an insertable card alters the functionality of said device.

5. The device of claim 1, wherein said housing comprises a mode selector having a plurality of modes, in communication with said control logic, such that the functionality of said device in response to the actuation of a touch sensitive region is related to said selected mode.

6. The device of claim 5, wherein said housing comprises a speaker, adapted to output said media file associated with said actuated touch region.

7. The device of claim 5, wherein said modes are selected from the group consisting of music, record, playback, trivia and unlock.

8. A device for media playback comprising:
a plurality of individually removable buttons, each of said buttons having a storage element comprising one or more media files, and
a housing having a plurality of openings, each adapted to hold one of said buttons, and
control logic in communication with said buttons, such that actuation of said buttons causes the commencement of said media file associated with said actuated button, and wherein said device comprises an illuminating feature corresponding to each of said plurality of individually removable buttons, such that the illuminating feature associated with said actuated individually removable button is activated.

9. (canceled)

10. The device of claim 8, wherein a plurality of media files is associated with each individually removable button.

11. The device of claim 8, wherein said storage element further comprises instructions executable by said control logic, such that insertion of an insertable card alters the functionality of said device.

12-15. (canceled)

16. The device of claim 1, wherein said media files are selected from the group consisting of audio files, video files and pictures.

17. A device comprising:
an insertable card comprising a plurality of button images and a storage element comprising one or more executable files; and
a housing containing:
a plurality of touch sensitive regions, positioned on said device such that each of said plurality of button images on said insertable card align with a corresponding underlying touch sensitive region such that pressing a button image causes actuation of said underlying corresponding touch sensitive region; and
control logic in communication with said touch sensitive regions and said executable files, such that actuation of said touch sensitive regions interacts with said executable file, and wherein the replacement of said insertable card causes different executable files to be available to said device.

18. The device of claim 17, wherein said executable files comprise games.

19. The device of claim 18, wherein a plurality of games are stored in said storage element, and one of said plurality of touch sensitive regions is used to select one of said plurality of games.

20. The device of claim 17, wherein said device comprises an illuminating feature corresponding to each of said plurality of touch sensitive regions, such that the illuminating feature associated with said actuated touch sensitive region is activated.

21. The device of claim 1, wherein a plurality of touch sensitive regions are simultaneously actuated to access additional media files.

22. The device of claim 1, wherein a media file comprises vocals and other elements, and actuation of a touch sensitive region is used to disable said vocals of said media file.

23. The device of claim 17, wherein a plurality of touch sensitive regions are simultaneously actuated to access additional executable files.

24. The device of claim 8, wherein a plurality of touch sensitive regions are simultaneously actuated to access additional media files.

25. The device of claim 8, wherein a media file comprises vocals and other elements, and actuation of a touch sensitive region is used to disable said vocals of said media file.
